(19) United States
(12) Patent Application Publication
(10) Pub. No.: US 2025/0327441 A1
(43) Pub. Date: Oct. 23, 2025

(54) FOUR-COLUMN FLOATING WIND TURBINE FOUNDATIONS

(71) Applicant: Principle Power, Inc., Emeryville, CA (US)

(72) Inventors: Seth Price, Berkeley, CA (US); Antoine Peiffer, Oakland, CA (US); Bradley Ling, Portland, OR (US); Cyril Godreau, Lisbon (PT); Bruce Martin, Houston, TX (US); Daewoong Son, Alameda, CA (US); Surya Banumurthy, Lafayette, CA (US); Ishan Jyoti Sharma, Houston, TX (US); Yannick Debruyne, Porto (PT); Nicolas Germain, Marseille (FR)

(21) Appl. No.: 18/951,361

(22) Filed: Nov. 18, 2024

Related U.S. Application Data
(60) Provisional application No. 63/637,848, filed on Apr. 23, 2024.

(51) Int. Cl. F03D 13/25; B63B 35/44; B63B 39/03

(52) U.S. Cl. CPC F03D 13/256; B63B 35/44; B63B 39/03; B63B 2035/446; F05B 2240/93

(57) ABSTRACT

A floatable, semi-submersible platform for a wind turbine includes a central turbine-tower-hosting column and three or more stabilizing columns. Upper main beams connect the top ends of the stabilizing columns to a top node that is itself connected about the turbine-tower-hosting column. Lower main beams connect the bottom ends of the stabilizing columns to a bottom node that is also connected about the turbine-tower-hosting column. Fixed ballast components may be located within the turbine-tower-hosting column and within the lower main beams. Hull trim compartments for containing ballast may be provided in the three stabilizing columns, and/or lower main beams, with transfer of ballast between the compartments being controlled by a hull trim system (HTS).

### CROSS-REFERENCE TO RELATED CASES

The present application claims priority to U.S. Provisional Patent Application No. 63/637,848, entitled “Four-Column Floating Wind Turbine Foundations,” filed on Apr. 23, 2024, which is hereby incorporated by reference in its entirety.

The present application is related to the following U.S. patent applications: U.S. patent application Ser. No. 12/988,121, entitled “Column-Stabilized Offshore Platform With Water-Entrapment Plates And Asymmetric Mooring System For Support Of Offshore Wind Turbines,” filed Oct. 15, 2010, now U.S. Pat. No. 8,471,396; U.S. patent application Ser. No. 14/283,051, entitled “System and Method for Controlling Offshore Floating Wind Turbine Platforms,” filed May 20, 2014, now U.S. Pat. No. 9,879,654; U.S. patent application Ser. No. 15/186,307, entitled “Floating Wind Turbine Platform Structure with Optimized Transfer of Wave and Wind Loads,” filed Jun. 17, 2016, now U.S. Pat. No. 9,810,204; U.S. patent application Ser. No. 16/427,208, entitled “Floating Wind Turbine Platform Controlled To Optimize Power Production And Reduce Loading,” filed May 30, 2019, now U.S. Pat. No. 11,225,945; U.S. patent application Ser. No. 17/428,986, entitled “Wind Energy Power Plant And Method Of Construction,” filed Aug. 6, 2021; and U.S. patent application Ser. No. 18/681,205, entitled “Floating Wind Turbine Platform,” filed Feb. 5, 2024, which are each hereby incorporated by reference in their entirety.

### BACKGROUND

Offshore wind energy is a very promising source of renewable energy for the reason that offshore wind is more intense and uniform than on-land wind. To harness wind energy in deeper water further offshore, one solution is to build floating wind turbines. Floating wind turbines face technical challenges that are different from both on-land wind turbines and floating oil and gas platforms.

In contrast to onshore wind turbines, a floating wind turbine requires a platform that provides buoyancy to support the weight of the whole structure. The structure of the platform may have several columns with large diameters. Besides providing buoyancy, the platform combined with the wind turbine generator should be able to resist dynamic wind, wave, and current loads in operating conditions and extreme conditions, and provide a stable support for power production. Another challenge is the added fatigue damage from wave loading, which might be comparable to that from wind loading. These extreme loads coming for the large wave and wind storms and the fatigue loads coming from normal operation require the platform to have a robust structural design to achieve structural integrity and better reliability over the lifetime of an offshore wind project.

In addition, as wind turbines are growing larger, the engineering requirements for both the tower and the floating platform change. The challenge is to design and build an optimal system from a full project lifecycle cost perspective at large commercial scale. As a result, designers and manufacturers are increasingly focused on standardization of their products for floating wind turbine platforms.

Thus, what is desired are wind turbine platforms that minimize cost, weight, and maximize performance for offshore wind turbines and particularly for larger wind turbines, e.g., those with the ability to produce greater than 15 MW.

### BRIEF DESCRIPTION OF THE DRAWINGS

The embodiments are illustrated by way of example and not limitation in the accompanying drawings, in which:

FIG. 1 is a perspective view of an embodiment of a four-column floating wind turbine foundation in a use case;

FIG. 2 is a perspective view of the embodiment of a four-column floating wind turbine foundation of FIG. 1;

FIG. 3 is a chart illustrating concepts related to embodiments;

FIG. 4 is a perspective view illustrating aspects of the embodiment of a four-column floating wind turbine foundation of FIG. 1;

FIG. 5 is a side view illustrating aspects of the embodiment of a four-column floating wind turbine foundation of FIG. 1;

FIG. 6 is a top view illustrating aspects of the embodiment of a four-column floating wind turbine foundation of FIG. 1;

FIG. 7 is a top view illustrating aspects of the embodiment of a four-column floating wind turbine foundation of FIG. 1;

FIG. 8 is a top view illustrating aspects of the embodiment of a four-column floating wind turbine foundation of FIG. 1;

FIGS. 9A-9D are side views illustrating the cross sections indicated in FIGS. 6-8;

FIG. 10 is a top view illustrating aspects of the embodiment of a four-column floating wind turbine foundation of FIG. 1;

FIG. 11 is a top view illustrating aspects of the embodiment of a four-column floating wind turbine foundation of FIG. 1;

FIG. 12 is a perspective view illustrating aspects of the embodiment of a four-column floating wind turbine foundation of FIG. 1;

FIG. 13A is an upper perspective view illustrating additional aspects of an embodiment of the cross-section indicated in FIGS. 6-8;

FIG. 13B is an upper perspective view illustrating additional aspects of an embodiment of the cross-section indicated in FIGS. 6-8;

FIG. 14 is a perspective view illustrating aspects of the embodiment of a four-column floating wind turbine foundation of FIG. 1;

FIG. 15 is a perspective view illustrating aspects of the embodiment of a four-column floating wind turbine foundation of FIG. 1;

FIG. 16 is a perspective view illustrating aspects of the embodiment of a four-column floating wind turbine foundation of FIG. 1;

FIG. 17 is a perspective view illustrating aspects of the embodiment of a four-column floating wind turbine foundation of FIG. 1;

FIG. 18 is a perspective view of an embodiment of an embodiment of a four-column floating wind turbine foundation;

FIG. 19 is an upper perspective view illustrating additional aspects of an embodiment of the embodiment of FIG. 18;

FIG. 20 illustrates a floating wind turbine platform with decoupled marine system and wind turbine controllers according to an embodiment;

FIG. 21 is a flowchart for an integrated controller according to an embodiment; and

FIG. 22 conceptually illustrates an example electronic system with which some embodiments of the subject technology may be implemented.

### DETAILED DESCRIPTION

A structure of a floating, semi-submersible wind turbine is provided. The floating wind turbine platform includes at least four columns, each having a top end, a keel end, and an outer shell. The columns may be interconnected by a combination of bracing members.

In embodiments, one of these columns supports a horizontal axis wind turbine and tower, with the wind turbine tower directly above and concentric with a column (the “turbine-hosting column” or “turbine-supporting column”). The other three columns are support or stabilizing columns, providing the required hydrostatic stability to resist the overturning moment created by the operating wind turbine. In an embodiment, one of these columns may support a vertical axis wind turbine without departing from the teachings of this disclosure.

To float at the target displacement of the platform, additional fixed mass may be added to the platform in the form of water ballast or other permanent ballast materials, such as concrete.

The turbine-tower hosting column may maintain the same outer diameter as the tower at the connection point, or it may feature a constant larger outer diameter or even a variable outer diameter that changes from the top of column to the bottom keel. If it has a larger outer diameter, it may switch to a hexagonal shape constructed of flat stiffened panels.

The turbine-tower hosting column, the stabilizing columns as well as some of the brace members (pontoons for instance) may be subdivided into one or more watertight compartments for different purposes, such as water ballast tanks, voids, or machinery rooms.

The outer stabilizing columns may be cylindrical, polygonal, or they may be hexagonal. Their outer diameter or equivalent outer diameter could potentially vary from bottom keel to top of column.

The system may or may not have a hull trim system (HTS), which may also be referred to as an active ballast system, and which is described in more detail under the Optional Features list.

The floating platform would be moored to the seabed with a long-term mooring system to keep the platform on station. One or more mooring lines would attach to each stabilizing column, and optionally to the tower-hosting column. None of the design variations rely on the mooring system for hydrodynamic stability or hydrodynamic response; the mooring system is just a station keeping system.

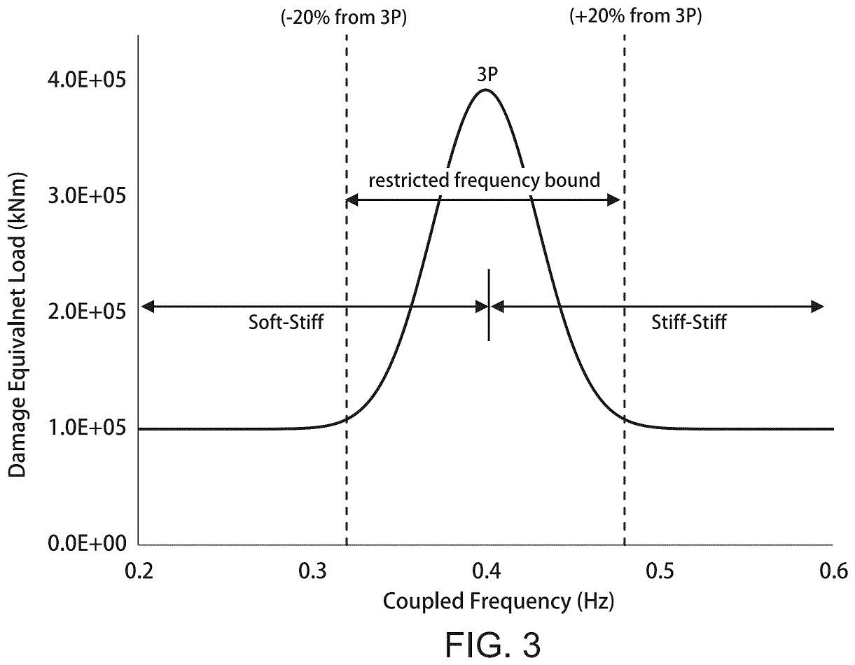

As described within, embodiments offer one or more of the following features and advantages. The semi-submersible platform may be constructed rigidly enough to meet criteria for stiff-stiff wind turbine towers. The semi-submersible platform may be constructed using proven assembly techniques for both flat panel assemblies and cylindrical assemblies. A centrally located tower-hosting column reduces destabilizing yaw moment and removes direction-dependent eigenfrequencies (EF). Low platform inertia enabled by, e.g., central column configuration, ballast locations, mass distribution, and/or variable plate thicknesses, provides for an increased coupled eigenfrequency that separates the floating wind turbine from the 3P resonance frequency, which is desirable for floating wind turbines that operate in the stiff-stiff eigenfrequency range (discussed in more detail with reference to FIG. 3). The central column configuration is a compact configuration that enables minimizing column size and platform footprint, which provides benefits in the areas of reduced platform inertia, fabrication, storage, transportation, and installation. Distribution of buoyancy compartments enables integration in shallow water ports (e.g., with a depth of at least 8m), and adds the flexibility to manage any late mass deviations in as-designed or as-built system. Columns and major components are suitable for stiffened flat panel construction as described in detail in one or more of the incorporated references for manufacturing cylindrical or hexagonal columns. Such manufacturing methods are compatible with existing automated fabrication lines for cylindrical and flat panel geometries, ensuring compatibility with the full range of supply chain scenarios for delivering floating wind projects. Hull trim systems incorporated into the semi-submersible platform provide an annual energy production (AEP) gain, a reduction in loading of the wind turbine tower, and allow for reducing the overall mass of the platform in comparison to passive systems.

As described within, embodiments offer one or more of the following optional features and advantages. Various combinations of these features may be combined when compatible: a) water entrapment plates (WEPs), or skirts, on the center column at the keel location; b) water entrapment plates on the outer columns (WEPs are larger flat plates that extend beyond the outer edge of the column keel. WEPs serve to increase the hydrodynamic added mass of the platform and increase the hydrodynamic damping to reduce dynamic motions of the platform); c) the bracing members between the turbine-hosting column and the supporting perimeter columns could be either rectangular sections or tubular sections (these members may consist of an upper main beam (upper box beam), lower main beam (pontoon), diagonal braces connecting the upper section to the lower section, or any combination of these); d) outer bracing members connecting the supporting columns (these could be either tubular or rectangular bracing members with the possible combination of sections described above); e) outer bracing members connecting the mid-sections of two adjacent lower main beams (these could be either tubular or rectangular box bracing members); e) flat gussets, similar to water entrapment plates, may be added to the joint between the turbine-hosting column and the lower bracing members; f) the turbine tower-hosting column may be cylindrical matching the outer diameter of the wind turbine tower, it may be cylindrical with a change in outer diameter, or it could be hexagonal; g) the outer stabilizing columns could be cylindrical or polygonal, e.g., hexagonal (their outer diameter or equivalent outer diameter could potentially vary from bottom keel to top of column); and h) a hull trim system (HTS, or active ballast system (ABS)) may be used to provide features described above and within.

In embodiments that include a hull trim system (HTS), water ballast is moved between the columns (HTS compartments) to compensate for variable wind turbine thrust loads resulting from changes in average wind speed and direction. Equipping a floating wind turbine with an HTS improves power production during operation by keeping the tower's mean pitch angle at an optimum angle, which may be zero degrees or an angle chosen to maximize the area of the blade plane that is perpendicular to the oncoming wind. Compared to fully passive semi-submersibles, embodiments equipped with an HTS optimize power production, which may boost AEP up to 2% compared to equivalent passive platforms. In addition, an HTS minimizes wind turbine loads during operation and enables the designer to achieve a more optimal platform mass and footprint. An HTS is entirely closed loop, meaning no water is exchanged between the platform and the environment. A particular benefit of HTS for floating wind turbines in the stiff-stiff regime is that the HTS allows for using less passive hydrostatic restoring stiffness because the HTS will keep the floating wind turbine upright, which means the mass of the semi-submersible platform may be reduced considerably. For example, providing less passive hydrostatic restoring stiffness may allow a reduction in the stabilizing column diameter and/or reduce the required spacing between turbine tower-hosting column and the stabilizing columns. This may reduce the amount of steel required in the platform, reduce the total platform inertia (resulting in an increased coupled tower/platform eigenfrequency), and potentially improve the hydrodynamic performance of the system by increasing the stability of the floating wind turbine, which reduces loads on the wind turbine.

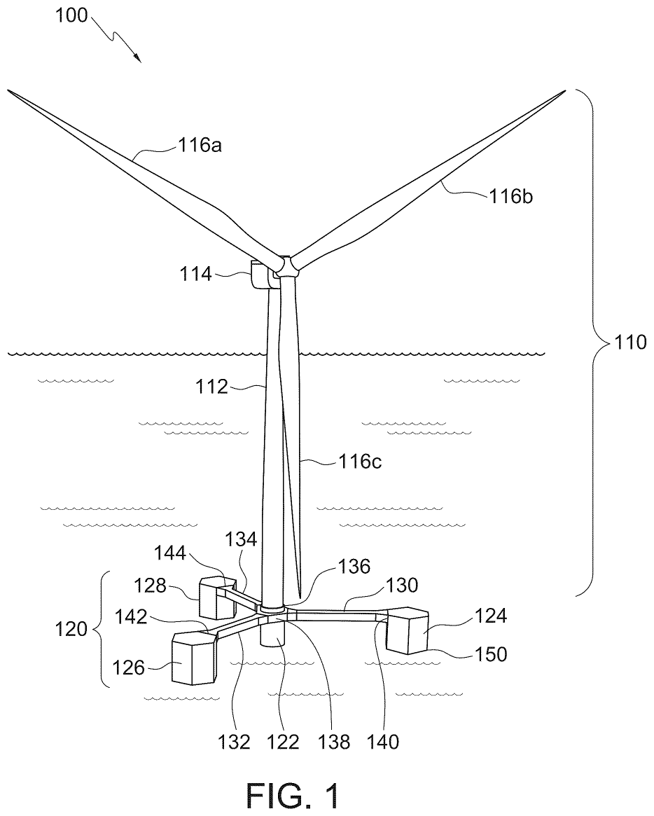

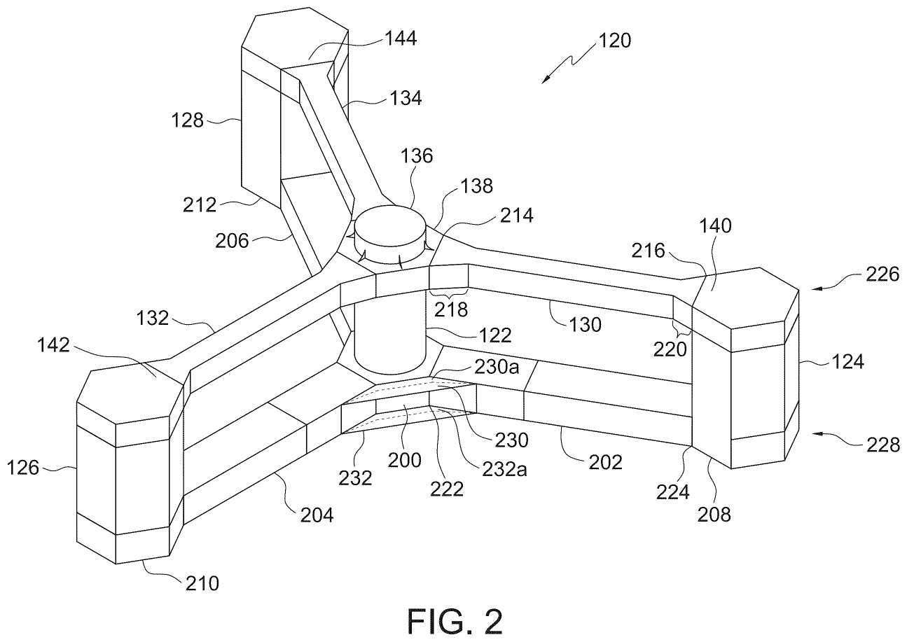

FIG. 1 is a perspective view of a floating wind turbine 100, which is a use case for a four-column floating wind turbine foundation—a semi-submersible platform 120—where platform 120 hosts a wind turbine 110. Wind turbine 110 includes a turbine 114 atop a turbine tower 112. Turbine 114 is powered by wind causing turbine blades 116a . . . 116c to rotate an axle (not shown) of wind turbine 110. Wind turbine 110 is joined to semi-submersible platform 120 at a tower-platform connection 136. Semi-submersible platform 120 includes a turbine-tower-hosting column 122 that is connected to each stabilizing column 124, 126, 128 by a top tower column node 138, a bottom node 200 (FIG. 2), and a pair of beams: upper main beams 130, 132, 134 (UMB) and lower main beams (LMB) 202, 204, 206 (FIG. 2). Each UMB 130, 132, 134 is connected to top node 138 and at a top node 140, 142, 144 of the respective stabilizing column. Bottom node 200 and LMBs 202, 204, 206 are obscured below a waterline 150 of floating wind turbine 100. In general, in the description that follows, when one plate section is disclosed as being connected to another plate section, the method of that connection should be understood to include the welding of the two sections together. Also generally, when plate sections are shown to be adjacent, intersecting, or in contact, it should be understood that they are connected.

FIG. 2 is a perspective view of semi-submersible platform 120 of FIG. 1. In FIG. 2, LMBs 202, 204, 206 are shown to be connected to bottom node 200 and a bottom node 208, 210, 212 (FIG. 2) at a keel end 228 of the respective stabilizing column 124, 126, 128. LMBs 202, 204, 206 may also be called pontoons and provide buoyancy. As depicted in FIG. 2, UMBs 130 . . . 134 each include a trapezoidal extension (e.g., representative trapezoidal extension 218 shown for UMB 130) at an end connected to top tower hosting column node 138 at a connection plane 214, and a trapezoidal extension (e.g., representative trapezoidal extension 220 shown for UMB 130) at an end connected to top stabilizing column node 140 at a connection plane 216. Between trapezoidal extensions 218, 220, each UMB 130, 132, 134 has a rectangular cross-section. Each LMB 202, 204, 206 has a rectangular cross-section between a connection plane 222 at which the LMB is connected to the bottom tower hosting column node and a connection 224 at which the LMB is connected to the bottom stabilizing column node, e.g., node 208. For reference, each column may be considered to have a top end, e.g., top end 226 of column 124, and the keel end, e.g., keel end 228 of column 124.

In this embodiment, top tower hosting column node 138 has a hexagonal cross-section and extends peripherally from cylindrical turbine tower-hosting column 122. In this embodiment, the hexagonal cross-section is irregular such that the sides to which trapezoidal extensions 218 are connected are longer than the intervening sides. In an embodiment, the intervening sides may be longer than sides to which trapezoidal extensions 218 are connected. In an embodiment, node 138 may have a regular hexagonal cross-section. Top tower hosting column node 138 provides additional structural continuity to the connection between the center column and UMBs 130 . . . 132, to improve the strength and fatigue life of this connection.

In the embodiment of FIG. 2, bottom tower hosting column node 200, between the turbine tower hosting column 122 and pontoons 202, 204, 206, may have a hexagonal cross-section, where the width of the pontoon matches the side length of the hexagon. The hexagon shape may have six equal sizes (i.e., be a regular hexagon), or may have unequal sides where the side that meets the pontoons is a different length than the open side (i.e., be an irregular hexagon).

In this embodiment, turbine-tower-hosting column 122 is cylindrical and continues through bottom tower hosting column node 200. In an embodiment, turbine-tower-hosting column 122 may be cylindrical until it meets the pontoon. That is, the cylindrical structure of tower hosting column 122 may continue through inside the hexagonal shape, or it can terminate at the top side of the hexagon, i.e., column node 200.

The depiction shows an axisymmetric design, with all outer columns having the same diameter, and equal angular spacing between each column. However, it may be desirable to not have as much symmetry, with different column outer diameters and angular spacing between each of the three outer columns.

In an embodiment, bottom tower-hosting column node 200 may have gussets connected between adjacent pairs of LMBs to increase the stiffness of the LMBs 202 . . . 206 at their connection to bottom node 200 and reduce flexing about the vertical axis. For example, flat upper gussets may be connected to the top of the node between adjacent pairs of LMBs 202 . . . 206. A representative flat upper gusset 230 is shown connecting the upper edges of LMB 202, column node 200, and LMB 204. Similar gussets may connect the upper edges of: LMB 204, column node 200, and LMB 206; and LMB 206, column node 200, and LMB 202. Flat lower gussets may similarly be connected to the bottom of the node between adjacent pairs of LMBs 202 . . . 206. A representative flat lower gusset 232 is shown connecting the lower edges of LMB 202, column node 200, and LMB 204. In the embodiment, gussets 230, 232 are thin planar structures, horizontally oriented, that connect neighboring pontoons to each other as well as to the node. Gussets 230, 232 may have straight outer edges. They may or may not be stiffened with additional structural members or brackets. These gussets increase the lateral bending stiffness of the pontoon-to-node connection without adding significant displaced volume to the structure. They also help with the hydrodynamic response of the platform by increasing the hydrodynamic added mass without significantly increasing the total platform inertia.

In an embodiment, upper and lower gussets 230, 232 may have a different profile, as seen from above, and as shown by dotted lines indicated by reference numbers 230a, 232a. For example, the profile of gussets 230a, 232a differs from that of gussets 230, 232 by not having a straight outer edge. Instead, gussets 230a, 232a have a somewhat “boomerang” shape. That is, the gusset width is narrow at the ends that are connected to the LMBs and the gusset width ramps up to a thickness that remains relatively constant for a center section that is connected to both node 200 and the adjacent LMBs. As with gussets 230, 232, planar upper gussets 230a may be connected to the top of the node and to adjacent pairs of LMBs 202 . . . 206. Similar planar gussets may connect the upper edges of: LMB 204, column node 200, and LMB 206; and LMB 206, column node 200, and LMB 202. And planar lower gussets 232a may be connected to the bottom of the node and to adjacent pairs of LMBs 202 . . . 206. The boomerang shape of gussets 230a, 232a reduces the area of the gusset in comparison to gussets 230, 232, which results in both a reduction of mass and a reduction in the moment of inertia. In an embodiment, planar gussets 230a, 232a may be metal plates that have a thickness of 50 mm in the center section.

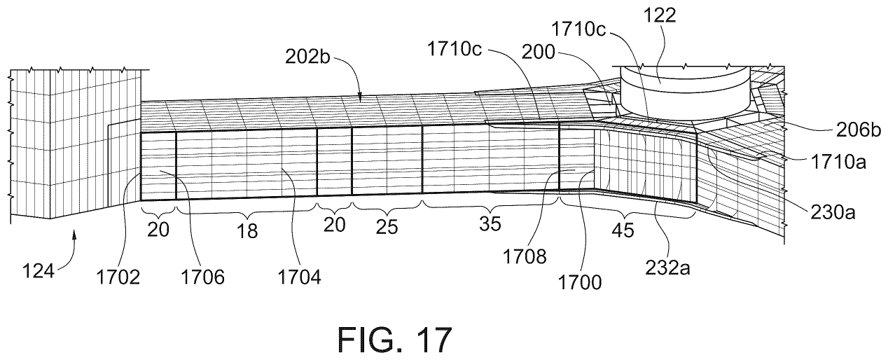

In an embodiment, one or both of gussets 230a, 232a may be integrated into the main beams and node to which they are attached. For example, in FIG. 17, upper gusset 230a is a single, solid insert plate that includes sections 1710a, 1710b, 1710c. Section 1710a, 1710b, 1710c are integrated into the top side of the LMB or node to which they are attached. In other words, gusset plate section 1710c is inserted into LMB 202b and welded in place. Plate section 1710c may or may not replace a corresponding plate section of LMB 202b. Similarly, gusset plate sections 1710b and 1710c are integrated into the top layers of bottom node 200 and LMB 206b, respectively. This description of gusset 230a applies equally to gusset 232a and the bottom sides of the node and LMBs. Generally, gussets 230, 230a, 232, 232a may be varied in dimension, shape, and location as needed to provide improved strength and fatigue response. For example, in FIG. 17, bottom gusset 232a may have “insert plate” sections similar to 1710a . . . 1710c and the upper gusset may be constructed as described with regard to FIG. 2 and gusset 230.

As illustrated, stabilizing columns 122, 124, 126 may be hexagonal in shape. The side length of the stabilizing columns may match the width of the LMBs 202, 024, 206 (pontoons). It may be possible to also have the LMB width be narrower than the width of one side of the hexagon. It may also be possible to have the width of the pontoon flare outwards near the connection 224 with the stabilizing column to meet one or two sides of the hexagonal columns. Such an outward flare is illustrated by trapezoidal extension 220 for UMB 130.

In an embodiment, one or more diagonal braces may be connected to a LMB from the turbine tower hosting column and/or UMB. For example, a brace may extend from the tower hosting column from just below the UMB and connect to the LMB a distance from the tower hosting column. In an embodiment, the brace may create 45 deg angles with the tower hosting column and the LMB. Braces may also be located at or near mid-space between two adjacent lower pontoons, or between two adjacent upper braces. Such braces between adjacent LMBs or UMBs are a potential way to have more “weak axis” rigidity in the structure while possibly limiting the size and mass of the LMBs or UMBs.

FIG. 3 is a chart illustrating concepts related to embodiments. In FIG. 3, the Y-axis shows a fatigue limit state (FLS) damage equivalent load (DEL) at an interface height (i.e., tower platform connection 136). The X-axis shows a coupled frequency (Hz) representing the natural frequency of the coupled wind turbine tower 112 when mounted onto the semi-submersible platform 120. The 3P frequency is the frequency of blades from a 3-bladed turbine passing the exemplary turbine tower at the turbine's rated wind speed. The FLS DEL is elevated in a restricted frequency bound that reaches a maximum at the 3P value (0.4 Hz in this use case) and drops below an acceptable FLS DEL value (arbitrarily shown to be flat lines) below 80% of the 3P value (0.32 Hz in this use case) and above 120% of the 3P value (0.48 Hz in this use case). The restricted frequency bound is so named due to the potential for damage to the floating wind turbine. A stiff-stiff region indicates where the natural frequency of the coupled wind turbine tower 112 when mounted onto the semi-submersible platform 120 is above the 3P frequency. A soft-stiff region indicates where the natural frequency of the coupled wind turbine tower 112 when mounted onto the semi-submersible platform 120 is below the 3P frequency. An acceptable soft-stiff region exists below the restricted frequency band and an acceptable stiff-stiff region exists above the restricted frequency band.

In this use case, the acceptable FLS DEL value is just above 1.0E+05 kNm for the given wind turbine, which had a power generating capacity of 15 MW. The FLS DEL may be provided by the wind turbine manufacturer and the corresponding acceptable soft-stiff and stiff-stiff regions are defined according to levels of separation typically set at 20% from the 3P frequency at rated rotor speed.

As stated, wind turbines are trending larger, which drives the need for a stiffer wind turbine tower. Such “stiff-stiff” wind turbine towers are likely to be used on wind turbines with power generating capacities above 15 MW. This raises the typical soft-stiff tower coupled frequency from the acceptable soft-stiff region into the restricted frequency band. As a result, modifications should be made to the turbine tower and/or semi-submersible platform to drive the coupled frequency higher and into the acceptable stiff-stiff region—that region in which the coupled frequency is greater than 0.4 Hz for this use case. An increased eigenfrequency that results in a tower/semi-submersible platform being “stiff-stiff” is an eigenfrequency—the first tower-dominated coupled natural frequency—that is greater than the nominal blade passing frequency of the wind turbine generator by some margin when it is operating at rated rotor speed. The benefit of the increased eigenfrequency being in the stiff-stiff region with sufficient separation from the 3P frequency is that the system will respond less to the passing of a blade, which will reduce fatigue loads on the tower/base connection.

The various embodiments describe semi-submersible platforms and features that enable the semi-submersible platform to be stiff enough so that, when coupled to a given “stiff” wind turbine, the natural frequency of the coupled wind turbine tower falls in the acceptable stiff-stiff region that is 20% higher than the 3P frequency of the given wind turbine. Generally, it has been found that a coupled frequency that is 120% of the 3P frequency results in a FLS DEL value that is acceptable. However, due to the ability of manufacturers to improve the tower platform connection 136, it is envisioned that coupled frequencies of less than 120% will become acceptable at some point. However, such improvements will come with mass and manufacturability costs and it is likely that a coupled frequency of at least 110-115% of the 3P frequency will be a lower limit for the acceptable stiff-stiff range. Similarly, a coupled frequency of at least 85-90% of the 3P frequency will be an upper limit for the acceptable soft-stiff range.

In FIG. 3, the 3P frequency is a blade passing frequency for an exemplary three-bladed wind turbine. The potential for damage (FLS DEL) is due to the oscillation of aerodynamic loading of each blade at the 1P frequency due to the higher wind speeds occurring at higher elevations. This oscillating load occurs on each blade with a phase offset, which manifests as a load on the tower oscillating at the blade passing frequency. Thus, a blade-passing frequency is the relevant data. For example, in FIG. 3, should the tower have four blades, but all else remaining equal, the relevant blade passing frequency (would be relabeled “4P”) would increase to 0.53 Hz (given P=0.13 Hz), while separation requirements between blade and tower frequencies would be set around this new 4P frequency.

FIG. 3 may be used to illustrate the benefits of one or more features of the semi-submersible platforms described herein. For a given wind turbine, the turbine and tower characteristics are typically pre-determined by the manufacturer. The wind turbine will have a given height, mass, inertia, rated rotational speed, and power rating. Thus, to drive the coupled eigenfrequency into the stiff-stiff region, it is desirable to be able to modify the design of the semi-submersible platform. A first way to drive the coupled eigenfrequency higher is to reduce the moment of inertia or the rotational inertia of the semi-submersible platform. By reducing the moment of inertia of the platform, the ratio of wind turbine inertia to platform inertia will be increased. Also, reducing the mass of the platform and distributing the mass of the platform strategically close to the tower-hosting column will reduce moment of inertia of the semi-submersible platform. Embodiments that employ an HTS enable the meaningful reduction in platform inertia because such embodiments may spread their platform mass over a smaller footprint to achieve lower required hydrostatic stiffness than for passive systems. In contrast, platforms that rely on only passive, fixed ballast must have a considerably greater mass, or spread their mass over a larger footprint, or a combination of both. This leads to a way to reduce the moment of inertia, which is to concentrate mass toward the center of the platform. This may be accomplished by decreasing the footprint of the platform and by locating heavier elements more centrally.

The coupled eigenfrequency (o cwt, shown as the “coupled frequency” in FIG. 3) is the eigenfrequency of the tower when coupled to a semi-submersible platform, as opposed to the eigenfrequency of the tower when fixed to an immovable base. The coupled eigenfrequency is driven by, primarily: 1) the eigenfrequency of the tower when fixed to an immovable base (ω fwt); 2) the inertia of the wind turbine (I wt, of the complete wind turbine 110); and 3) the inertia of the semi-submersible platform (I ssp, of the semi-submersible platform 120) according to the following approximate relationship:

$$ω c wt \approx ω fwt \sqrt{( 1 + [ I wt / I ssp ]} \qquad ( Equation 1 )$$

In EQN 1, I ssp is the inertia of the semi-submersible platform including any hydrodynamic added inertia, due to the virtual mass of water that is harnessed by surfaces of, e.g., water entrapment plates and connection members, such as pontoons when the platform moves through the water. As can be seen from EQN 1, a way to drive the coupled eigenfrequency higher is to increase the ratio of the wind turbine inertia to the semi-submersible platform inertia. In order to do this without modifying the wind turbine, the inertia of the semi-submersible platform must be reduced. For example, for a given tower with an eigenfrequency of the fixed tower (ω fwt) of 0.3 Hz, and a target minimum coupled eigenfrequency (ω cwt) of 0.48 Hz (or 20% greater than 3P as shown in FIG. 3), the ratio of inertia of the wind turbine to the inertia of the semi-submersible platform (I wt/I ssp) is preferably greater than 1.560.

As is generally known, the moment of inertia (I) depends on the mass and the square of the distances (rᵢ) of mass components (mᵢ) from a center of gravity (CG):

$$I = \sum {m}_{i} {r}_{i}^{2} \qquad ( Equation 2 )$$

As this is being applied to a body submerged in water, the hydrodynamic added inertia of the submerged portion of the semi-submersible platform also contributes to the total inertia of the system.

Thus, embodiments may employ a number of the following strategies to reduce the inertia of the semi-submersible platform. The turbine tower may be located over the central column (the turbine-tower hosting column) to decrease the distance of the wind turbine (turbine and turbine tower) from the CG of the system. The fixed ballast may be concentrated centrally to reduce the mass of the fixed ballast from the CG of the system. Upper and lower main beams may connect radially between the central column and the stabilizing columns, which decreases the mass of the beams from the CG of the system in comparison to platforms having main beams that connect between pairs of stabilizing columns.

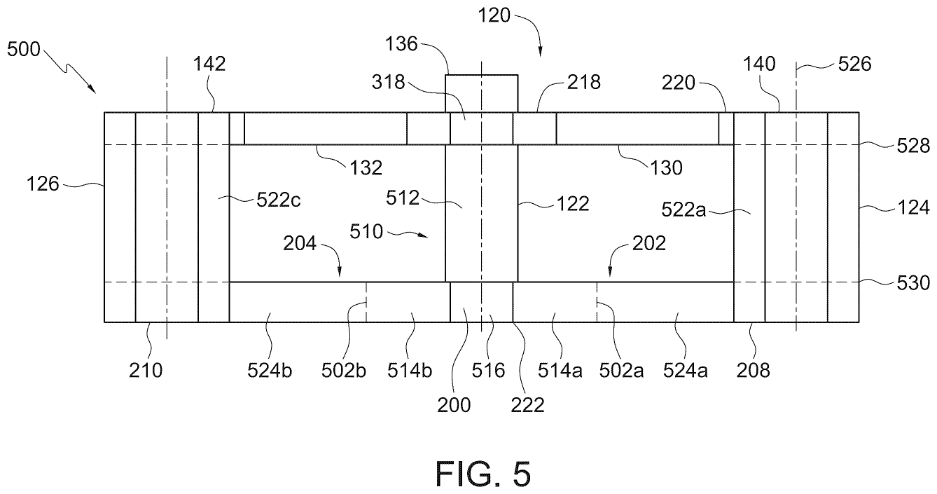

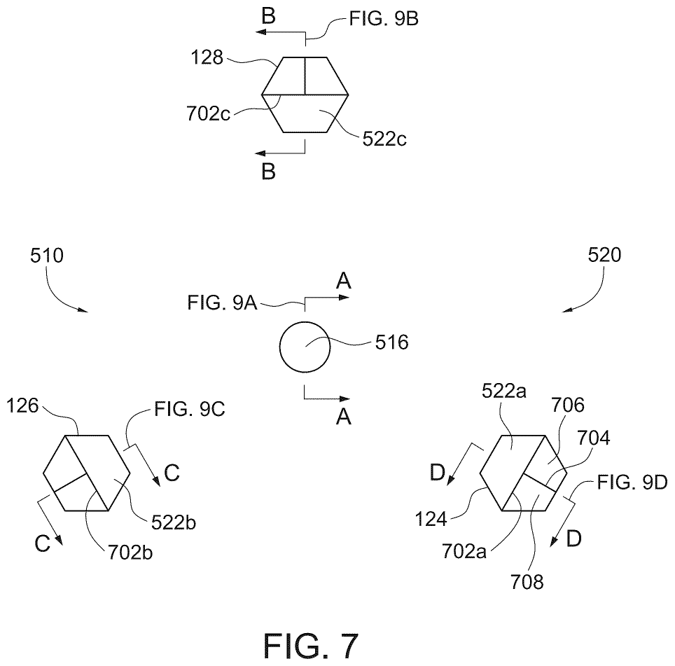

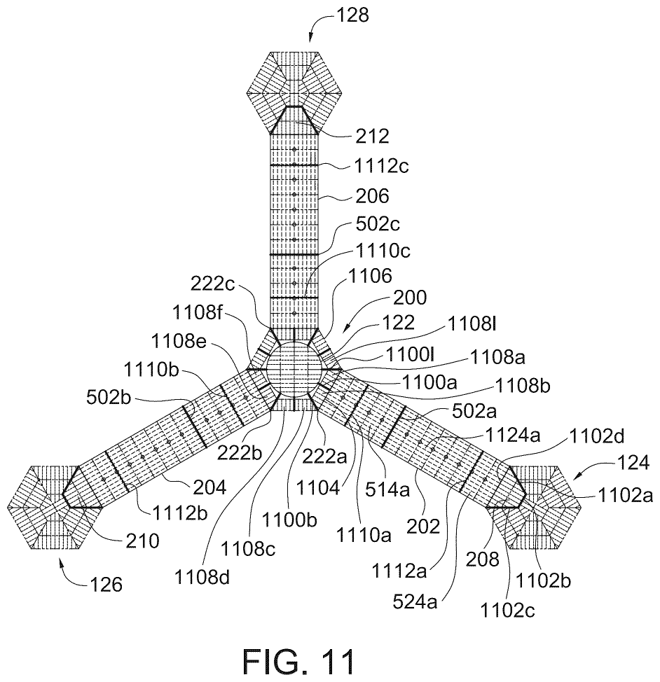

In an embodiment, using one or more of these strategies to reduce the inertia of the semi-submersible platform results in a platform with relatively smaller columns of larger span from the central column, and a resulting minimizing of steel mass and the associated cost. For example, transferable ballast may be located in the inboard side of stabilizing columns, as discussed with regard to, e.g., FIG. 5, FIG. 7, and FIG. 11. Such locating of the transferrable ballast centrally (or biasing the transferrable ballast toward the center of the platform) results in a net benefit of an increased eigenfrequency because the volume of transferable ballast (e.g., water) required increases linearly with decreasing distance from the lateral CG of the system, while the inertia contribution of the transferable ballast decreases quadratically with a linear decrease in distance from the lateral CG of the system. Thus, locating the transferable ballast on the inboard side of the column yields a net reduction in rotational inertia while maintaining the same restoring moment.

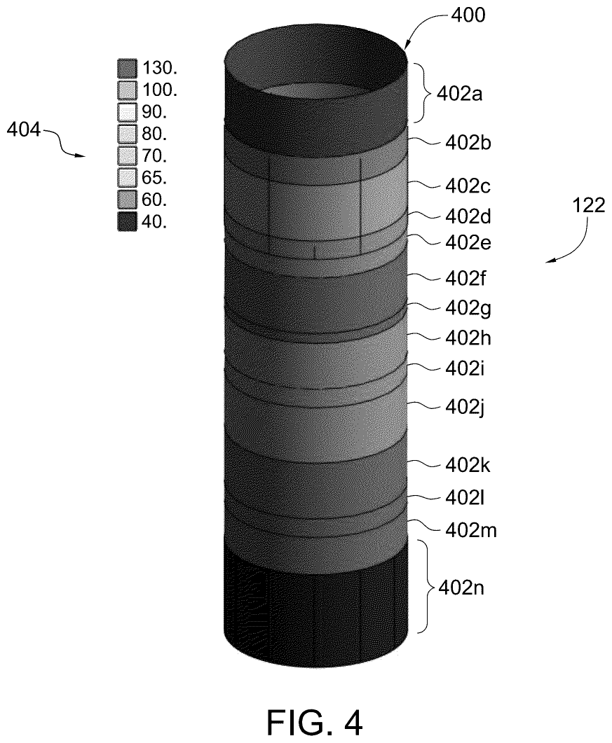

Embodiments illustrate reducing the mass of the platform where the several drawings indicate that different thicknesses of plate are used. The different plate thickness represent a tailoring of the plate to the stresses experienced at the plate location. In this way, by tailoring the plate thicknesses, mass is reduced by making the plating thinned when the stresses allow. Such tailoring is illustrated in FIG. 4 and FIGS. 12-17. Furthermore, an exemplary passive platform for supporting the same wind turbine would be considerably heavier. For example, for the same wind turbine 110, a passive platform would be at least 150-250 tons more massive when sized just to accommodate the accelerations and loading of the system. But, to match the annual energy production (AEP) of a system that is equipped with HTS, the passive system would need to be much heavier to achieve the requisite hydrodynamic stiffness—so much heavier that it may be practically infeasible to design such a platform.

Embodiments also illustrate reducing the moment of inertia of the platform by moving elements toward the center of the platform. For example, FIGS. 5-10 illustrate that stabilizing column ballast compartments 522a . . . 522c are biased toward tower-hosting column 122. Additionally, FIG. 11 illustrates that both fixed ballast compartments and compartments for transferable ballast that are located in LMBs 202, 204, 206 may be moved toward tower-hosting column 122 to decrease rotational inertia. In addition, making fixed ballast denser, e.g., concrete instead of water, would reduce the footprint of that ballast. For example, for the same wind turbine 110, a passive platform would have a moment of inertia that is greater than that of an HTS-equipped system when the passive system is sized just to accommodate the acceleration and loading of the system. But to match the annual energy production (AEP) of a system that is equipped with HTS, the passive system has a moment of inertia much greater than that of a HTS-equipped system—so much greater that it may be practically infeasible to design a passive platform that is both hydrodynamically stiff enough to match the AEP of a system that is equipped with a HTS, and has a moment of inertia low enough to have an acceptable coupled eigenfrequency, e.g., a coupled eigenfrequency greater than 110% of the 3P frequency.

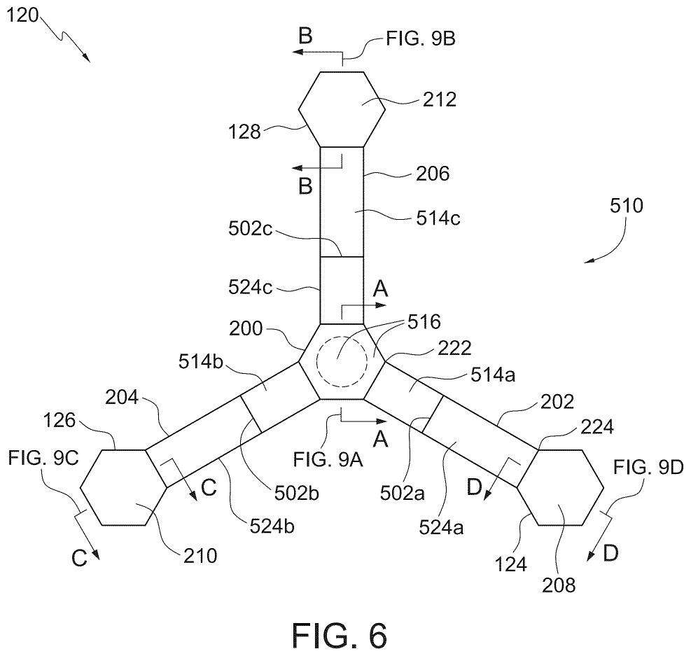

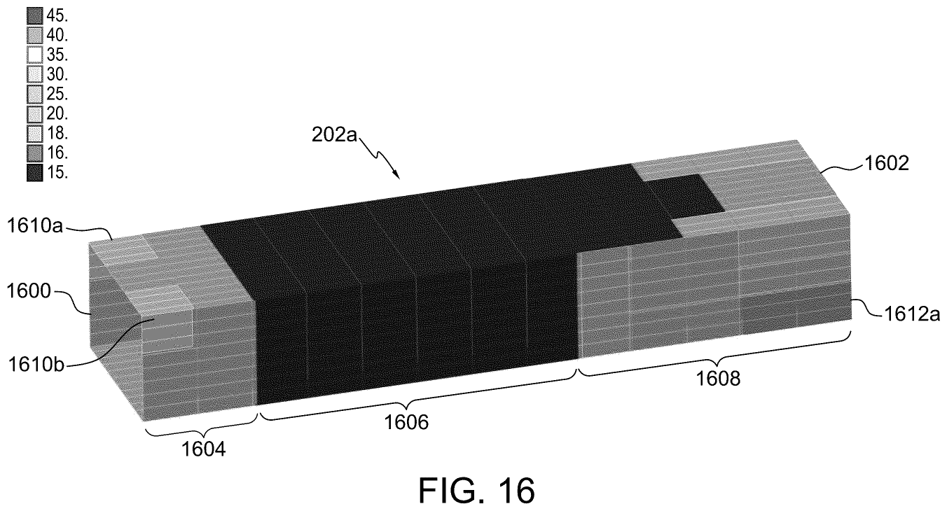

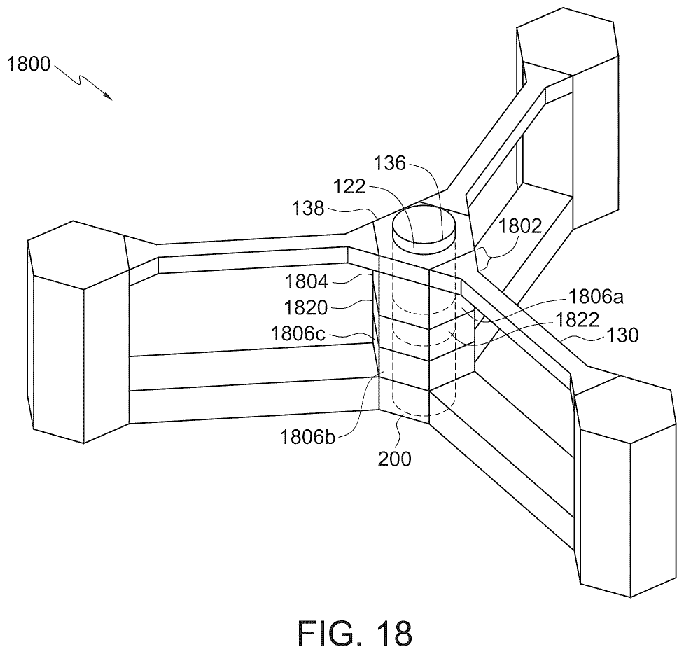

An example of the beneficial reduction in rotational inertia provided by an embodiment of, e.g., the embodiment of FIG. 1 and FIG. 18, may be illustrated with reference to a floating wind turbine platform having only three columns, each column at the vertex of a horizontal triangle, and with the turbine tower in vertical alignment over one of the corner columns. In the 3-column platform, each corner column is directly connected to both other corner columns. An exemplary 3-column floating wind turbine may have the following properties: the two corner columns that do not support the wind turbine may each have a displacement of X tons; the turbine-supporting column may have a displacement of Y tons (which includes the turbine tower and turbine); the 3-column platform may have a footprint that fits within a circle of radius R; and the 3-column floating wind turbine may have a rotational inertia of Z kgm². This Z inertia is relatively large because the inertia is calculated with each displacement X, X, and Y being at radius R from the center of the platform's footprint. An exemplary 4-column floating wind turbine may have the following properties: three perimeter stabilizing columns, each with ⅔ X tons displacement (resulting in a total stabilizing column displacement of 2X tons); the 3 stabilizing columns may have the same footprint that fits within the circle of radius R; the turbine supporting column may have the same Y displacement and be located at the center of the footprint (R=0) between the three stabilizing columns; and the 4-column floating wind turbine may have a rotational inertia I that is significantly less than Z. I is significantly less than Z because, in the 4-column floating wind turbine, the tower-supporting column has been moved from the perimeter to the center of the footprint, which reduces if not eliminates the contribution of the tower-supporting column to the platform's rotational inertial. Embodiments described in this disclosure may generally leverage the beneficial aspect of moving mass toward the center of the platform in order to reduce rotational inertia. For example, ballast, both fixed and transferable, may be centrally located, or biased toward the center of the platform (see FIG. 6-FIG. 8). Stabilizing columns may be made relatively lighter. And UMBs and LMBs may be constructed such that the steel plate used decreases in thickness as the beam gets further from the platform center (see FIG. 16 and FIG. 17).

Reductions in inertia may also be obtained using a Hull Trim System (HTS). Through the design phase, most wind turbine manufacturers (WTM) enforce a limit on the maximum mean heel angle permissible for a wind turbine (WT) to operate within throughout its service life. Additionally, larger heel angles are typically discouraged because they lead to a reduction in power production due to the reduction in the effective rotor area exposed to the wind. Larger heel angles can increase loads on the tower and WT components. An HTS may be used to address these challenges and minimize platform tilt. The HTS counterbalances the overturning moment caused by the operating WT with a ballast shift during turbine operation and minimizes negative impacts on power production that would be amplified in a system with no HTS.

An important design metric to quantify how the floating platform will react to the overturning moment imposed by the WT is the design heel angle (DHA). DHA is the mean heel angle the platform hits when the turbine is operating at the wind speed that results in the maximum thrust if there was not a HTS (as in a fully passive system). For an example case with example wind turbine requirements, a passive system without an HTS will have a DHA of approximately 5 degrees. The same platform equipped with an HTS will have its DHA increased to approximately 7 degrees.

For a passive system, the DHA is directly constrained by the maximum permissible heel angle specified by the WTM and the physical architecture (draft, footprint, column diameter) of the platform. However, for a floating platform equipped with an HTS, the DHA is not constrained as much and can be increased to improve the behavior of the platform at sea. So, in summary, the HTS allows the platform to be designed with a higher DHA than what is possible with a passive system. And having a higher DHA allows for semi-submersible platforms that are both lighter weight and higher performing as measured by AEP.

Importantly, there is a collateral benefit to the inclusion of an HTS on a stiff-stiff system design. Because HTS-enabled platforms can meet DHA limits with smaller dimensions (e.g., footprint) and less weight, the rotational inertia of an HTS-enabled platform may be lower. The smaller rotational inertia increases the coupled tower frequency, and thus increases the separation of the coupled frequency from the 3P exclusion zone. Thus, using an HTS allows also using a semi-submersible platform that is lighter and has a smaller footprint than passive platforms in a floating wind turbine that satisfies the separation requirement of the coupled frequency.

FIG. 4 is a perspective view illustrating aspects of the embodiment of a four-column floating wind turbine foundation of FIG. 1. In FIG. 4, tower-hosting column 122 is illustrated to show changes in a thickness 400 of the tower side at different column sections 402a . . . 402m. Table 1 lists the thickness of each section and the section height. As can be seen from Table 1, the thickness of tower-hosting column 122 decreases from an initial thickness of 130 mm to a final thickness of 40 mm. This decrease is accomplished by a series of incremental steps down to 60 mm, then an increase to 65 mm for the upper splash zone piece, which is made thicker to fortify that zone against the environment, then a further decrease in two steps to 40 mm. Thus, thickness 400 of tower-hosting column 122 may generally taper from an initial thickness 402a that is greatest at tower platform connection 136 to a final thickness 402n that is least at bottom tower hosting node 200.

TABLE 1

| | | Thickness | Beginning | Ending |
|---|---|---|---|---|
| Section | Section name | (mm) | height (m) | height (m) |
| 402a | Transition | 130 | 27.5 | 30.64 |
| | piece 1 | | | |
| 402b | Transition | 100 | 26.0 | 27.5 |
| | piece 2 | | | |
| 402c | Upper node | 90 | 23.0 | 26.0 |
| | piece 1 | | | |
| 402d | Upper node | 80 | 22.0 | 23.0 |
| | piece 2 | | | |
| 402e | Above splash | 70 | 21.0 | 22.0 |
| | zone piece 1 | | | |
| 402f, g | Above splash | 60 | 17.45 | 21.00 |
| | zone piece 2 | | | |
| | (collectively) | | | |
| 402h, 402i, 402j | Upper splash | 65 | 11.00 | 17.45 |
| | zone piece | | | |
| | (collectively) | | | |
| 402k, 402l, 402m | Below mean | 60 | 5.00 | 11.00 |
| | water line piece | | | |
| | (collectively) | | | |
| 402n | Lower node | 40 | 0.0 | 5.00 |
| | piece | | | |

In an embodiment, tower-hosting column 122 may have the dimensions listed in Table 2, which, like Table 1, lists the thickness of each section and the section height. As can be seen from Table 2, the thickness of tower-hosting column 122 decreases from an initial thickness of 100 mm to a final thickness of 40 mm. This decrease is accomplished by a series of incremental steps down to 65 mm, which is held for a part of the column largely corresponding to the splash zone. Below 11.00m, the thickness further decreases to 60 mm and then 40 mm at the keel end.

TABLE 2

| Description or | Thickness | Beginning height | Ending height |
|---|---|---|---|
| Note | (mm) | (m) | (m) |
| | 100 | 25.50 | 28.44 |
| Node 138 | 90 | 24.00 | 25.50 |
| connects to | 80 | 21.00 | 24.00 |
| column 122 | | | |
| between | | | |
| 22.00 m and | | | |
| 26.00 m | | | |
| | 70 | 17.50 | 21.00 |
| A splash zone | 65 | 14.25 | 17.50 |
| extends | 65 | 11.00 | 14.25 |
| between | | | |
| 10.87 m and | | | |
| 17.32 m | | | |
| | 60 | 7.00 | 11.00 |
| Bottom Node | 60 | 4.00 | 7.00 |
| 200 connects | 40 | 0.0 | 4.00 |
| to column 122 | | | |
| between | | | |
| 0.00 m and | | | |
| 5.00 m | | | |

A note about Table 1 and Table 2, plate thicknesses and plate thicknesses in general. The plate thicknesses indicated in Table 1 and Table 2 and the several figures are illustrative and should not be understood to limit the embodiments. Plate thicknesses will vary depending on the stresses placed on a particular platform. And the stresses placed on a particular platform will vary depending on the environment in which the platform is placed, e.g., the wind speeds and speed profile and the wave action, which are unique to a particular site. Thus, the design of a semi-submersible platform may be tailored to the particular environment in which it will be installed. Furthermore, the design of a semi-submersible platform may be tailored to the properties of a particular wind turbine, e.g., wind turbine properties such as, mass, dimensions, and power rating and may be tailored to the particular local infrastructure that will be used to construct and deploy it.

FIG. 5 is a side view illustrating aspects of ballasting 500 for the semi-submersible platform 120 of FIG. 1. Ballasting 500 is for moving and maintaining floating wind turbine 100 to a level position or to a desired tilt in a desired direction. Ballasting 500 may include both fixed ballast 510, which remains in place, and transferable ballast 520, which may be transferred between ballast compartments. Fixed ballast 510 may also be provided as fixed ballast 512 within tower-hosting column 122. Fixed ballast 510 may be provided as fixed ballast 514a . . . 514c, each within a compartment within one of lower LMBs 202 . . . 206. Fixed ballast 510 may include fixed ballast 516 provided within bottom tower hosting column node 200, either within the section of tower-hosting column 122 that is within node 200, or within node 200 and outside of tower-hosting column 122, or both.

Transferable ballast 520 may include water or other liquid contained within stabilizing column ballast compartments 522a . . . 522c, which are located in stabilizing columns 124, 126, 128 between a bottom level 528 of top stabilizing column nodes 140, 142, 144, and a top level 530 of bottom stabilizing column nodes 208, 210, 212. Transferable ballast 520 may also include water or other liquid contained within LMB or pontoon ballast compartments 524a . . . 524c, each defined at an inner end by a bulkhead 502a . . . 502c within an LMB 202 . . . 206, respectively, and at an outer end by the node bulkhead, e.g., bulkhead 1102d (FIG. 11) at the connection, e.g., connection 224, between the LMB and the lower stabilizing column node.

In the embodiment, fixed ballast 510 is preferable biased or concentrated toward node 200 to minimize the rotational inertia of semi-submersible platform 120, which assists in increasing the natural frequency of the coupled wind turbine tower 112 when mounted onto the semi-submersible platform 120. Thus, fixed ballast 512 may be biased toward node 200 within column 122. Similarly, fixed ballast 514a . . . 514c may be biased toward node 200 within LMBs 202 . . . 206. In an embodiment, fixed ballast 500 may be concrete. In the embodiment, fixed ballast 500 may be water, e.g., provided in compartments located within bottom node 200, tower-hosting column 122, and/or compartments between bottom column node 200 and a bulkhead within each of LMBs 202 . . . 206, e.g., bulkheads 502a . . . 502c.

As with fixed ballast 510, transferable ballast 520 is preferably biased toward tower hosting column 122 to minimize the rotational inertia of semi-submersible platform 120, which assists in increasing the natural frequency of the coupled wind turbine tower 112 when mounted onto the semi-submersible platform 120. Thus, in the embodiment, stabilizing column ballast compartments 522a . . . 522c are biased toward the tower-hosting column 122-side of each stabilizing column and do not extend outboard of a center of each column (represented by a column center 526 for stabilizing column 124).

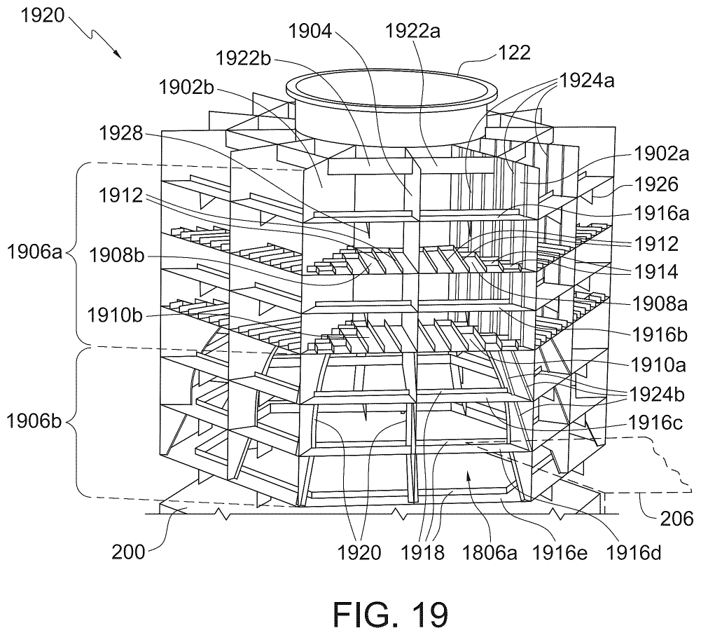

As is discussed with regard to FIG. 19 and references that have been incorporated by reference, transferable ballast 520 may be transferred between compartments using pumps to cause floating wind turbine to obtain and maintain a desired tilt, or lack thereof.

FIG. 6 is a top view illustrating aspects of fixed ballast 510 and transferrable ballast 520 of semi-submersible platform 120 of FIG. 1. FIG. 6 a horizontal cross-section through tower-hosting column 122 and each stabilizing column 124, 126, 128 at an elevation midway through the LMBs. FIG. 6 illustrates how fixed node ballast 516 may be provided both within and about the section of tower-hosting column 122 that passes through bottom tower hosting column node 200. Transferable ballast compartments 524a . . . 524c are located between bulkheads 502a . . . 502c and the sealed outer end of LMBs 202, 204, 206. In embodiments, the outer end may be sealed by a bulkhead sealing the LMB, or by the LMB being connected to the bottom stabilizing column node 208, 210, 212. Similarly, in an embodiment in which fixed ballast 514a . . . 514c is liquid ballast, fixed ballast compartments 514a . . . 514c are located between bulkheads 502a . . . 502c and the sealed inner end of LMBs 202, 204, 206. In embodiments, the inner end may be sealed by a bulkhead sealing the LMB, or by the LMB being connected to the bottom tower hosting column node 200. In an embodiment, bottom stabilizing column nodes 208, 210, 212 may be configured as ballast tanks for receiving transferable ballast.

FIG. 7 is a top view illustrating aspects of fixed ballast 510 and transferrable ballast 520 of semi-submersible platform 120 of FIG. 1. FIG. 7 shows a horizontal cross section through platform 120 between top tower-hosting column node 138 and bottom tower-hosting column node 200. Bulkheads 702a . . . 702c, one in each of stabilizing columns 124, 126, 128, extend between vertices of the hexagonal stabilizing column. In this manner, ballast compartments 522a . . . 522c are biased toward tower-hosting column 122 and do not extend outboard beyond the center of their respective stabilizing columns. In other embodiments, bulkheads 702 . . . 702c may be located both closer toward the center of the platform and further from the center of the platform without departing from the teachings of this disclosure, which is that the transferable ballast within each stabilizing cylinder is preferably biased at least partially toward the center of platform 120 to assist in minimizing platform inertia and maximizing the natural frequency of the coupled wind turbine tower 112.

With reference to stabilizing column 124, FIG. 7 illustrates further aspects that are common among columns 124, 126, 128. A bulkhead 704 may separate the part of each stabilizing column that is outboard from bulkhead 702a . . . 702c into separate spaces. In the embodiment, bulkhead 704 separates the outer half of stabilizing column 124 into a technical space 706 and a void 708. Technical space may generally contain the working apparatus of platform 120, e.g., ballast pumps, piping, and electrical components. Void 708 may generally be empty.

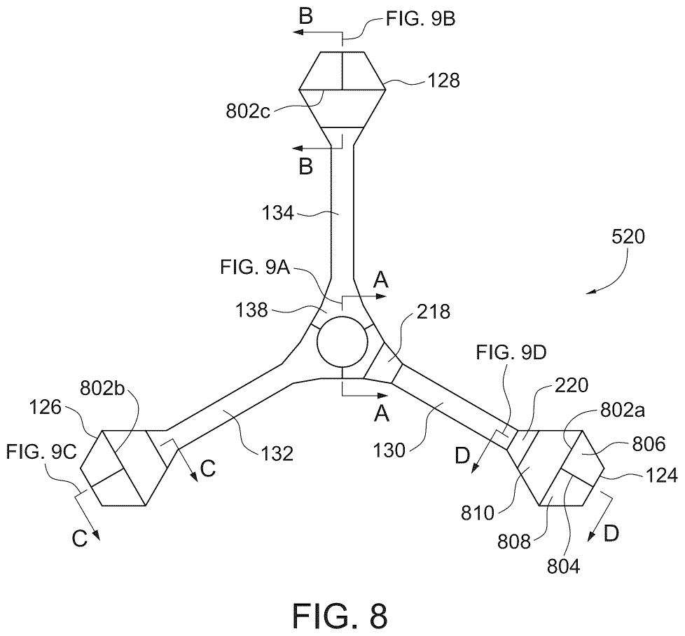

FIG. 8 is a top view illustrating aspects of fixed ballast 510 and transferrable ballast 520 of semi-submersible platform 120 of FIG. 1. FIG. 8 shows a horizontal cross-section through tower-hosting column 122 and each stabilizing column 124, 126, 128 at a level midway through the UMBs. In FIG. 8, each top stabilizing column node 140, 142, 144 includes a bulkhead 802a . . . 802c that separates the node into an inner void 810 (shown for representative node 140) an outer void 808 and an outer technical space 806, which corresponds to technical space 706 discussed earlier. UMBs 130, 132, 134 are generally voids as well, but also provide space for the ballast piping, electrical component, and platform personnel to pass between the stabilizing columns and the tower-hosting column.

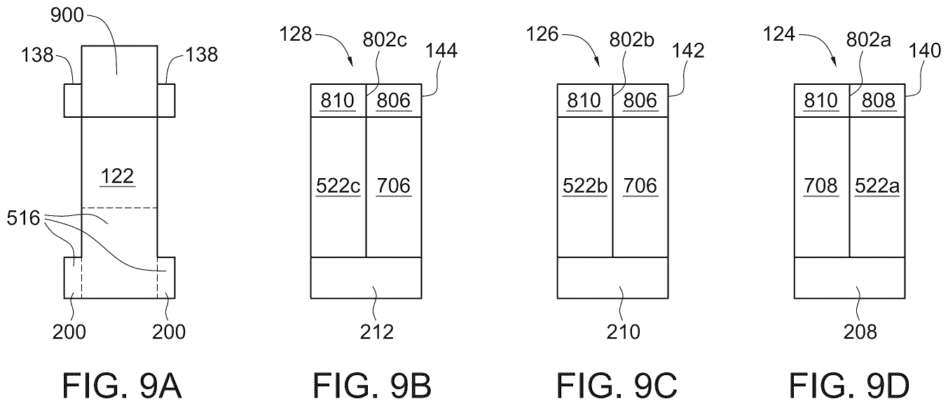

FIGS. 9A-9D are side views illustrating the cross sections indicated in FIGS. 6-8. FIG. 9A further illustrates that a technical space 900 may be provided within tower-hosting column 122.

As shown in FIG. 5-FIG. 9D, the columns and pontoons of the embodiment of FIG. 1, and any other embodiment within, may be subdivided internally with a combination of vertical bulkheads and flats to provide different watertight (e.g., fixed ballast and transferable ballast compartments) and/or airtight compartments. The subdivisions of columns and pontoons depicted in these figures are exemplary. In embodiments, the columns and pontoons may be subdivided internally with a combination of vertical bulkheads and flats to provide different watertight and/or airtight compartments. Some of these compartments may contain ballast water, while others may be voids or space for required machinery. In embodiments provided with a transferable ballast system, ballast compartments may be separated between transferable ballast and fixed ballast. In embodiments, transferable ballast compartments may be provided in each pontoon, or in each stabilizing column, or in both each pontoon and each stabilizing column. In an embodiment, a transferable ballast column may be provided in the turbine tower-hosting column, e.g., above or in place of all or part of fixed ballast 516. If using pontoon structures to connect columns 124 . . . 128, part or all of the pontoons may be used as fixed ballast compartments, e.g., compartments 514a and 524a may be partly or entirely fixed ballast. The pontoon tanks may be divided by a vertical bulkhead, e.g., bulkheads 502a . . . 502c. In other words, a notional compartmentation is illustrated in FIG. 5-FIG. 9D; however, the compartmentation layout may be modified to meet the specific ballast requirements for a specific wind turbine and semi-submersible platform design.

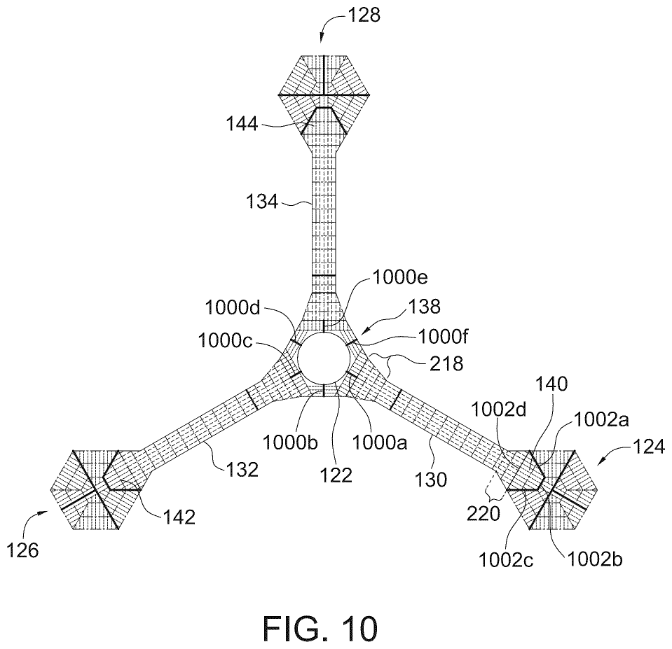

FIG. 10 is a top view illustrating aspects of semi-submersible platform 120 of FIG. 1, with the top layer of plating on UMBs 130, 132 and the top layer of plating on part of top tower hosting column node 138 rendered partially transparent to show internal components. FIG. 10 illustrates that top tower hosting column node 138 may have a regular, hexagonal cross-section with radial bulkheads 1000a . . . 1000f, each strengthening tower-hosting column 122 by extending column 122 to connect perpendicularly with a side of the hexagonal column node 138. With reference to stabilizing column 124, but applicable to each other stabilizing column, top stabilizing column node 140 may be provided with additional vertical bulkheads 1002a . . . 1002d, to strengthen the connection of the UMB to node 140. In an embodiment, bulkheads 1002a . . . 1002c may run the entire height of node 140. In an embodiment, one or more bulkheads 1002a . . . 1002d may be partial to allow for passage between technical spaces. FIG. 10 further illustrates that each trapezoidal section 218, 220 may flare from an initial width of UMB 130 to match a length of a side of the stabilizing or tower-supporting column to which it connects. With regards to trapezoidal section 220, the plane of the flared section may be co-planar with adjacent faces of the stabilizing column. With regard to trapezoidal section 218, the plane of the flared section may be at a slight angle with the adjacent faces of the top tower hosting column node, as shown in FIG. 10. However, in other embodiments, e.g., the embodiment of FIG. 18, the plane of the flared section may be co-planar with the adjacent faces of the top tower hosting column node. In an embodiment, additional radial bulkheads, similar to bulkheads 1000a . . . 1000f, may be provided as needed for strength between bulkheads 1000a . . . 1000f. For example, an additional radial bulkhead may be provided between each adjacent pair of bulkheads 1000a . . . 1000f and extend from column 122 to a vertex of the regular hexagonal node 140 (each similar to bulkhead 1100b of FIG. 11).

FIG. 11 is a top view illustrating aspects of semi-submersible platform 120 of FIG. 1, with the top layer of plating on LMBs 202, 204 and the top layer of plating on part of bottom tower hosting column node 200 rendered partially transparent to show internal components. FIG. 11 illustrates that bottom tower hosting column node 200 may have a regular, hexagonal cross-section with node faces connected to a LMB, e.g., node face 1104, and node faces exposed to the environment, e.g., node face 1106. Bottom tower hosting column node 200 may be provided with radial bulkheads 1100a . . . 1100l, each strengthening the tower-hosting column 122 to node connection by extending from column 122 to connect with a side or vertex of the hexagonal column node 200. With reference to stabilizing column 124, but applicable to each other stabilizing column, bottom stabilizing column node 208 may be provided with additional vertical bulkheads 1102a . . . 1102d, to strengthen the connection of the LMB to node 208. In an embodiment, bulkheads 1102a . . . 1102c may run the entire height of node 208 with plumbing added to allow ballast to be transferred as needed to and from the node. In an embodiment, additional radial bulkheads, similar to bulkheads 1100a . . . 1000l, may be provided as needed for strength between bulkheads 1100a . . . 1100l. For example, an additional radial bulkhead may be provided between each adjacent pair of existing bulkheads 1100a . . . 1100l and extend from column 122 to a halfway point between the existing connections, e.g., a bulkhead may extend radially from tower-hosting column 112 and connect at an angle to node face 1104. In the embodiment, bottom tower hosting column node 200 may be provided with an inner layer of horizontal peripheral girders 1108a . . . 1108l that extend inwardly and perpendicularly from the outer faces (e.g., node face 1104 and 1106) of node 200 and that connect between adjacent pairs of radial nodes, further stiffening node 200.

FIG. 11 illustrates that the location of ballasting compartments may be moved to influence the rotational inertia of semi-submersible platform 120. For example, moving ballasting compartments inward will reduce the platform rotational inertia. The following is described with reference to LMB 202, but similar modifications may be made to LMBs 204, 206. Fixed ballast may be more centrally located. Fixed compartment 514a, which is bounded by bulkhead 502a, may be replaced by a fixed compartment 1114a that is bounded by a bulkhead 1110a. Similarly, transferable ballast may be more centrally located. Transferable ballast compartment 524a, which is bounded by bulkhead 502a and by bulkhead 1102d, may be replaced by a fixed compartment 1124a that is bounded by bulkhead 1110a and a bulkhead 1112a.

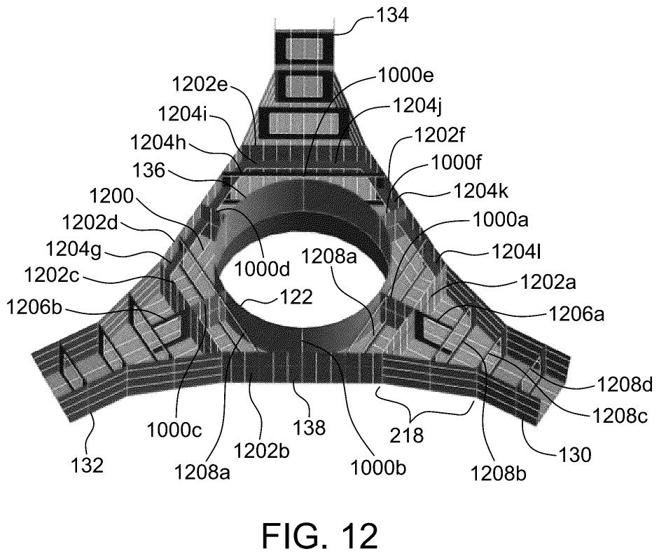

FIG. 12 is a perspective view illustrating aspects of top tower-hosting column node 138. FIG. 12 illustrates that node 138 may have an irregular hexagonal cross-section in the plane perpendicular to tower-hosting column 122, with exposed faces 1202b, 1202d, 1202f, being longer than internal faces 1202a, 1202c, 1202e, which are each a trapezoidal section. In the embodiment, top tower hosting column node 138 may be provided with an inner layer of horizontal bulkheads 1204a . . . 1204l (1204a . . . 1204f being obscured by the view angle) that extend inwardly and perpendicularly from the outer faces 1202a . . . 1202f and that connect between adjacent pairs of radial nodes 1000a . . . 1000f, further stiffening node 138. For further stiffening, the trapezoidal sections, e.g., section 218, may each be provided with C-shaped web frames (or bulkheads), i.e., 1206a . . . 1206c that connect a hexagon face 1202a, 1202c, or 1202f, to an internal ring brace 1208a, 1208b, 1208c about the interior of a trapezoidal section. Internal ring braces like 1208a may be provided about the interior of the UMB spaced throughout its length. In addition, each trapezoidal section on the outer end of the UMB may be similarly provided with a C-shaped web frame connecting the top stabilizing column node to an internal brace like 1208a about the interior of the trapezoidal section. In FIG. 12, it is more plainly visible that there is a slight angle between exposed faces 1202b, 1202d, 1202f and the sides of each adjacent trapezoidal section. This slight angle breaks up the change from the orientation of a node face, e.g., face 1202b, to the side of the extended middle section of adjacent UMBs 130, 132 into two steps: a first step occurring when vertical face 1202b transitions to a vertical side of trapezoidal section 218; and a second step occurring where the vertical side of trapezoidal section 218 transitions to a vertical size of the middle section of UMB 130. A potential benefit of having this change in orientation occur in two steps is that the stress experienced at each transition is less than what would occur if the transition was accomplished in a single step. In other words, a single step may amount to a stress riser, which is diminished by breaking the change into two steps.

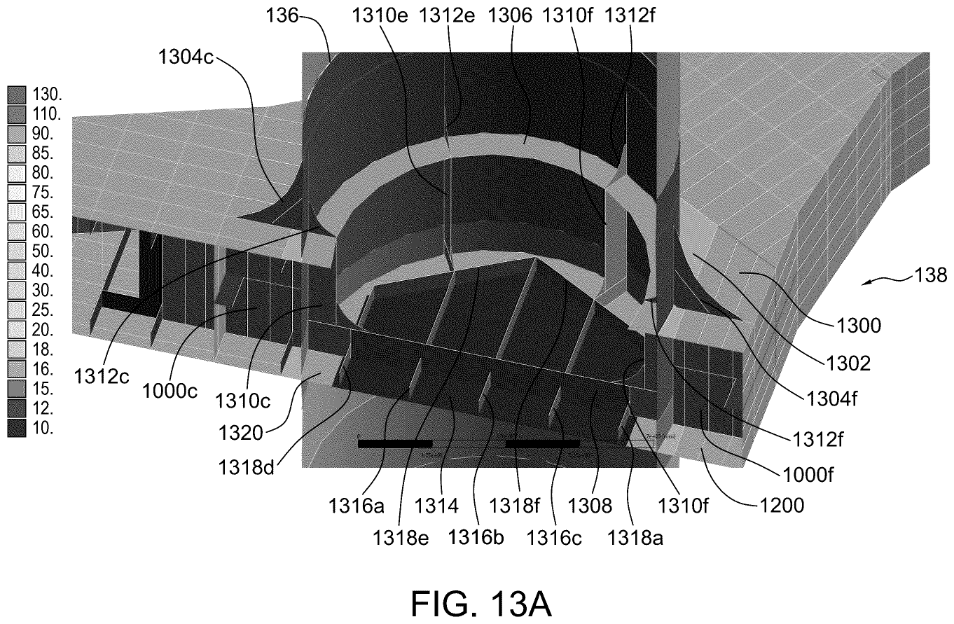

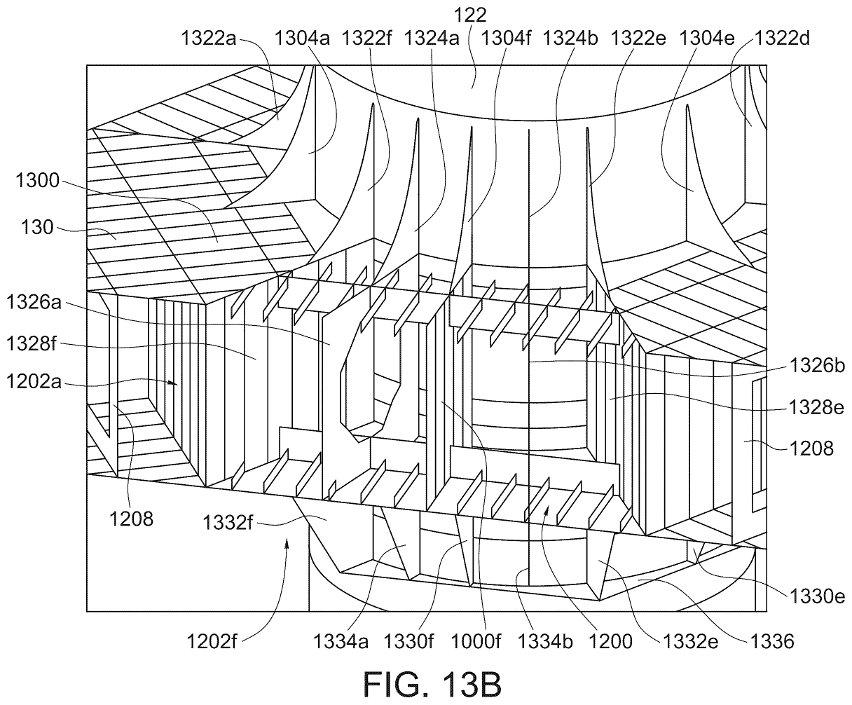

FIG. 13A is an upper perspective view illustrating additional aspects of the cross-section of FIG. 9A with shading to show varying plate thicknesses. The shading is different from that of FIG. 4, though both are 130 mm at the top of their scales. In FIG. 13A, top tower-hosting column node 138 includes an upper surface 1300 with an inner section 1302. Outer brackets 1304a . . . 1304f (brackets 1304b, 1304c, 1304e, 1304f are obscured due to the perspective), spaced evenly about the perimeter of tower-hosting column 122 connect column 122 to surfaces 1300 and inner section 1302, which stiffens the connection between column 122 and node 138. An interior ring stiffener 1306 may be provided at the top level of node 138 to further stiffen column 122. In an embodiment, ring stiffener 1306 may be replaced by a flat bulkhead that covers the entire open space within column 122. In addition, an interior perimeter section 1320 connected about a hexagonal plate section 1314 provides a floor or bottom surface of node 138. Plate section 1314 may be provided with a central stiffener 1308 that is in line with one of the UMBs, e.g., UMB 130. Plate section 1314 may be further stiffened by perimeter stiffeners 1318a . . . 1318f and by inner stiffeners 1316a . . . 1316c that run perpendicularly to central stiffener 1308. Spaced about the interior of column 122, and corresponding to the positions of external brackets 1304a . . . 1304f, inner brackets 1310a . . . 1310f connect interior ring stiffener 1306, column 122, interior perimeter section 1320, and perimeter stiffeners 1318a . . . 1318f. In this manner, in addition to the discussion of FIG. 12, top tower-hosting column node 138 and its connections to tower-hosting column 122 and UMBs 130, 132, 134 are made extremely stiff while the efficient use of varying plate thicknesses reduces mass and the associated cost of construction. In an embodiment, external brackets similar in design and space to brackets 1304a . . . 1304f may connect the lower side of node 138 to column 122 to further stiffen the column/node connection. In addition, in FIG. 13A, outer brackets 1304a . . . 1304f and bulkheads 1000a . . . 1000f are oriented such that an outer bracket, e.g., outer bracket 1304f, is aligned vertically above a bulkhead, e.g., bulkhead 1000f, with the alignment imparting further stiffness to node 138 and column connection

FIG. 13B is an upper perspective view illustrating additional aspects of an embodiment of the cross-section of FIG. 9A with surface plating on face 1202f of the node and partial top face of upper surface 1300 is rendered transparently to facilitate description of the interior. In FIG. 13B, an embodiment 138a of top tower-hosting column node 138 is generally as described with regard to FIG. 13A and this discussion will be directed to their differences. FIG. 13B generally illustrates that additional brackets (both upper and lower brackets) and bulkheads may be added to node 138a as needed to increase the stiffness of the node and column connection. In top tower-hosting column node 138a, outer brackets 1304a . . . 1304f have been augmented by outer brackets 1322a . . . 1322f (brackets 1322b . . . 1322c are obscured due to the perspective), which connect column 122 to face 1300 and extend radially from column 122 toward an intersection of an adjacent pair of faces. For example, outer bracket 1322f extends from column 122 along upper surface 1300 toward the intersection of face 1202f (which is transparent) and internal face 1202a. In an embodiment, additional outer brackets may be added approximately midway between each adjacent pair of outer brackets 1304a . . . 1304f and 1322a . . . f. This is illustrated for outer brackets 1322e, 1322f, and 1304f, in which outer brackets 1324a, 1324b extend radially from column 122 along upper surface 1300. Similarly, additional bulkheads may be added within node 138a beneath each added outer bracket to further stiffen node 138a. For example, beneath each of outer brackets 1322a . . . 1322f, an internal radial bulkhead 1328a . . . 1328f may be added. Each of bulkheads 1328a . . . 1328f may connect to column 122, upper surface 1300, lower surface 1200, and a pair of adjacent faces 1202a . . . 1202f at their intersection. And, beneath each of outer brackets 1324a, 1324b, an internal bulkhead 1326a, 1326b may be added to stiffen node 138a by connecting column 122, upper surface 1300, lower surface 1200, and one of faces 1202a . . . 1202f. As stated above, lower outer brackets may be added. In an embodiment, a lower bracket may be added in vertical alignment with each internal bulkhead. For example, lower outer brackets 1330a . . . 1330f are aligned vertically with one of bulkheads 1000a . . . 1000f and connect column 122, lower surface 1200 and a column perimeter flange 1336. Lower outer brackets 1332a . . . 1332f are aligned vertically with one of bulkheads 1328a . . . 1328f and connect column 122, lower surface 1200 and a column perimeter flange 1336. And lower outer brackets 1334a, 1334b may be added between bulkheads 1326a, 1326b and connect column 122, lower surface 1200 and a column perimeter flange 1336. As with bulkheads 1326a, 1326b, lower outer brackets 1334a, 1334b may be propagated about the perimeter of column 122 and connect column 122 to each face 1202a . . . 1202f. In the embodiment, a benefit of column perimeter flange 1336 is that force applied to node 138a may be transmitted further down column 122, and also that twisting of lower outer brackets 1330n, 1332n, and 1334n (where “n” indicates any of the group) is resisted. In the embodiment, a benefit of the vertical alignment of an upper outer bracket, an internal bulkhead, and a lower outer bracket (e.g., outer bracket 1304f, bulkhead 1000f, lower outer bracket 1330f) is an increase in stiffness in node 138a.

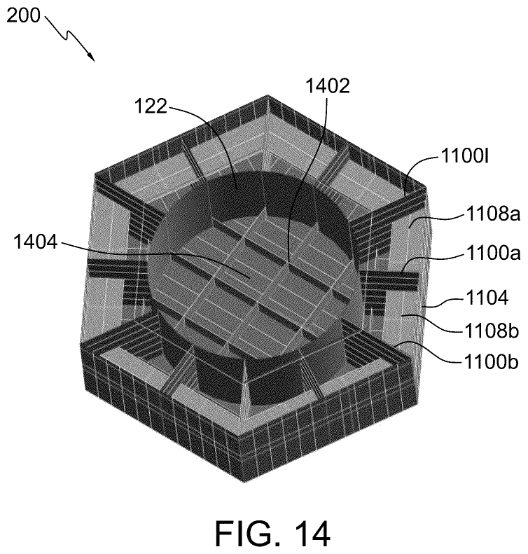

FIG. 14 is a perspective view illustrating aspects of bottom tower-hosting column node 200. FIG. 14 illustrates that node 200 may have a regular hexagonal cross-section in the plane perpendicular to tower-hosting column 122. The following description of node face 1104 applies equally to each node face. As discussed with regard to FIG. 11, vertical bulkheads 1100a . . . 1100l extend radially from column 122 and connect to either a midpoint of a node face, or to a vertex at the intersection of two node faces. In addition, horizontal peripheral girders 1108a . . . 1108l extend inwardly and perpendicularly from the outer faces (e.g., node face 1104) of node 200 and connect between adjacent pairs of radial nodes (e.g., radial nodes 1100a, 1100b), which further stiffens node 200. An interior plate section 1404 provides a bottom face or floor of node 200. Plate section 1404 may be stiffened by grid stiffeners 1402 that crisscross bottom section 1404, at which column 122 ends.

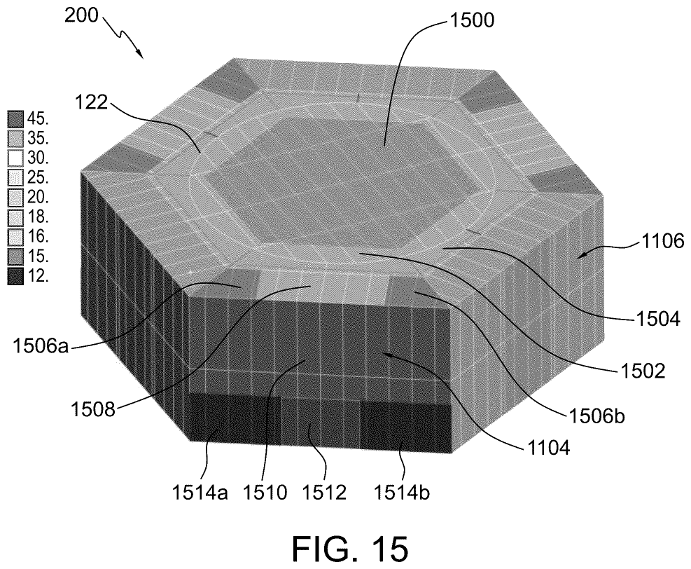

FIG. 15 is a perspective view illustrating additional aspects of bottom tower-hosting column node 200 with shading to show varying plate thicknesses. In FIG. 15, a central plate section 1500 and an inner perimeter plate section 1502 buttress the inner diameter of column 122. An outer perimeter plate section 1504 rings column 122 such that column 122 is sandwiched between inner and outer plate section 1502, 1504, which prevents column 122 from buckling. Bottom tower-hosting column node 200 is shown to be entirely enclosed by plate; however, the plate may vary in thickness according to its location and purpose. The following description is directed to node face 1104, to which LMB 202 is connected, but applies equally to the node faces to which LMBs 204, 206 are connected. Node face 1104 includes relatively sections 1514a, 1514b with relatively thickest plate at lower corners of the face that are attached to lower corners of a corresponding face of LMB 202. Between sections 1514a, 1514b is a section 1512 with slightly thinner plate. Sections 1506a, 1506b, which are equal to section 1512 in thickness, are provided on the top surface of node 200 and correspond to top corners of LMB 202. Between sections 1506a, 1506b is a section 1508 of somewhat thinner plate. Remaining section 1510 of face 1104 has the thinnest plate of the several sections. In this manner, in addition to the discussion of FIG. 14, bottom tower-hosting column node 200 and its connections to tower-hosting column 122 and LMBs 202, 204, 206 are made extremely stiff while the efficient use of varying plate thicknesses reduces mass and the associated cost of construction.

FIG. 16 is a perspective view illustrating additional aspects of an LMB 202a with shading to show varying plate thicknesses. LMB 202a may be used in place of each of LMBs 202, 204, 206, equally. The previous description of LMB 202 applies to LMB 202a, with the “a” designation indicating a particular configuration of a variety of plate thicknesses. In FIG. 16, LMB 200a includes an end 1600 for connecting to a tower stabilizing column, e.g., column 124 at connection 224, and an end 1602 for connecting to bottom tower-hosting column node 200 at, e.g., face 1104. LMB 202a may be considered to have an outer segment 1604 with generally relatively thicker plate, a middle segment 1606 with relatively thinner plate, and an inner segment 1608 with generally relatively thicker plate similar to inner segment 1604. Within outer segment 1604, relatively thicker plating is found at upper corners 1610a, 1610b for connecting to corresponding sections of a stabilizing column. Even thicker plate may be found at similar corner sections 1612a, 1612b (obscured by the perspective view) at inner end 1602 for connecting to corresponding sections of bottom node 200. Thus, LMB 202a is relatively stiffer in sections 1608 and 1604 than in section 1606. In addition, section 1608 is longer than section 1604, which stiffens LMB 202a at the point of connection to bottom tower-hosting column node 200, where stress is relatively greater than at end 1600, due to any force at end 1600 resulting in an increased force at end 1602 due to the moment arm of LMB 202a.

FIG. 17 is a perspective view illustrating additional aspects of an LMB 202b with shading to show varying plate thicknesses. LMB 202b may be used in place of each of LMBs 202, 204, 206, equally. The previous description of LMB 202 applies to LMB 202b, with the “b” designation indicating a particular configuration of a variety of plate thicknesses that is different from the plate thickness configuration of LMB 200a. In the following, LMB 200b is representative of each of the three LMBs in an embodiment of semi-submersible platform 120. Also, the discussion of the visible vertical side of LMB 202b applies equally to the obscured vertical side. In FIG. 17, LMB 200b includes an end 1700 for connecting to bottom tower-hosting column node 200 at, e.g., face 1104 (FIG. 11), and an end 1702 for connecting to a tower stabilizing column, e.g., column 124 at connection 224 (FIG. 2). LMB 202b may have an outer segment 1704 with generally relatively thinner plate on the vertical sides, an inner segment 1708 with relatively thicker plate on the vertical sides, and a number of middle segments in which the plate thicknesses on the vertical sides step down from inner segment 1708 to outer segment 1704, and then step up in plate thickness to segment 1706, which is immediately adjacent to stabilizing column 124. In FIG. 17, the thickness of the metal plate on the vertical sides of segment 1708, is 45 mm. The outer face of bottom node 200 also has plate that is 45 mm thick. The plate thicknesses then step down to 35 mm, 25 mm, 20 mm, and 18 mm at the thinnest in section 1704. Thus, LMB 202b has plate that is relatively thicker nearer to bottom node 200. As a result, LMB 202b is relatively stiffer in sections closer to node 200, which improves the resistance of the LMB to stress and fatigue caused by out-of-plane bending. The reduction in plate thickness from section 1708 to section 1704 also results in the center of mass of the LMBs being shifted toward the center of the platform, which results in a decrease in the moment of inertia. In addition, the use of thinner plate where possible, e.g., in sections nearer to the stabilizing column, reduces the mass of the LMB, which also reduces the moment of inertia. In an embodiment, within outer segment 1706, relatively thicker plate may be found at upper corners of section 1706 adjacent to stabilizing column 124, which are areas of relatively higher stress. In an embodiment, the top and bottom surfaces of LMB 202b may have sections in which their plate thicknesses decrease from being thicker in a section nearest to bottom node 200 to being relatively thinner in a section nearer (like the vertical sides, or adjacent to the stabilizing column.

FIG. 18 is a perspective view of an embodiment of a semi-submersible platform 1800 that may be combined with wind turbine 110 to create a floating wind turbine. In FIG. 18, semi-submersible platform 1800 is substantially similar to semi-submersible platform 120 and this discussion will be directed to the differences between the two platforms. A first difference regards top tower-hosting column node 138 and a trapezoidal section 1802. The difference is that the sides of trapezoidal sections 1802 are co-planar with adjacent sides of node 138. In other words, a face of node 138 and the faces of the trapezoidal sections 1802 on either side of the node face are in the same plane. A second difference is that each face of the hexagonal top tower-hosting column node 138 is connected to a face 1806a . . . 1806f (with 1806d . . . 1806f being obscured in the view) of a hexagonal outer tower-hosting column 1804, each of which is continued down to connect with the corresponding face of the bottom tower hosting column node 200. As a result, between top tower-hosting column node 138 and bottom tower hosting column node 200, tower-hosting column 122 is entirely encased within a hexagonal outer column 1804. Hexagonal outer tower-hosting column 1804, by coupling top and bottom tower-hosting column nodes 138, 200, increases the stiffness of semi-submersible platform 1800. Thus, in the embodiment, turbine tower-hosting column 122 continues from node 138 to bottom node 200 (as described with reference to the previous figures, e.g., FIG. 14) surrounded by outer tower-hosting column 1804.

FIG. 18 also illustrates an embodiment in which tower-hosting column 122 does not continue down through bottom tower hosting column node 200. Instead, a middle tower hosting column node 1820 may be provided at a desired middle section of hexagonal outer column 1804. Middle tower hosting column node 1820 may be substantially similar to node 200 as illustrated in FIG. 14, except that middle tower hosting column 1820 is located at a point between UMBs 130, 132, 134 and LMBs 202, 204, 206 and is therefore not connected to LMBs 202, 204, 206. Tower hosting column node 1820 may generally include radial bulkheads that extend from tower-hosting column 122 to hexagonal outer tower-hosting column 1804 to transfer load from column 122 to outer tower-hosting column 1804. Tower-hosting column 122 may be connected to middle tower hosting column node 1820 as shown in FIG. 14 and may not extend below node 1820. Instead, tower-hosting column 122 may end with a keel end 822 that is shown within node 1820. In such an embodiment, modifications to a bottom tower hosting column node 200 that are made to account for the deletion of tower-hosting column 122 may include the extension of radial bulkheads 1100a . . . 1100l to a central point and the deletion of grid stiffeners 1402. A feature of hexagonal outer tower-hosting column 1804 is that it provides additional structure at high load regions along the turbine-hosting column and UMBs, and turbine-hosting column and LMBs.

The embodiment depicted in FIG. 18, illustrates that a turbine-hosting column may change diameter and/or shape at some point along the height of the platform, i.e., change from a cylindrical tower-hosting column 122 to a hexagonal outer tower-hosting column 1804. Where a tower-hosting column meets the turbine tower it may be tubular and match the outer diameter of the wind turbine tower. The shape and diameter change may happen above or below the connection with the top tower-hosting column node 138. The changes may also happen at the same elevation as the top of the bottom tower-hosting column node 200. The widths of the sides of the hexagonal outer tower-hosting column 1804 may match the LMB width, or they may be different. In addition, the hexagonal outer tower-hosting column 1804 may extend only partway upward from the bottom tower hosting column node 1804, e.g., hexagonal outer tower-hosting column 1804 may extend upward from the bottom tower hosting column node 1840 to middle tower hosting column node 1820.

In the embodiments, a column cross-section is often depicted as being hexagonal. However, embodiments are envisioned in which columns may have cross-sections of other shapes, such as polygonal cross-sections with greater or fewer sides, e.g., a pentagon or heptagon or octagon, and being regular or irregular polygons.

FIG. 19 is an upper perspective view illustrating additional aspects of an embodiment of the semi-submersible platform 1800 of FIG. 18. FIG. 19 illustrates an embodiment 1900 of node 1820 connecting tower-hosting column 122 to hexagonal outer tower-hosting column 1804. In FIG. 19, the outer faces 1806a . . . 1806f of hexagonal outer tower-hosting column 1804 are rendered transparently to facilitate description of node 1900. Furthermore, this description will be directed at the elements between column 122 and face 1806a of hexagonal outer tower-hosting column 1804, which extends between UMB 130 and LMB 202. LMB 206 is indicated using dashed lines for reference. Since node 1900 is symmetrical about tower-hosting column 122, this description will apply equally to the elements between column 122 and all faces 1806a . . . 1806f of hexagonal outer tower-hosting column 1804.

Node 1900, like top tower-hosting column node 138, may have a regular, hexagonal cross-section. Radial bulkheads 1902a, 1902b may connect column 122 to hexagonal outer column 1804 at a vertex at the connection of two adjacent faces, e.g., 1806f and 1806a, and 1806a and 1806b. A radial bulkhead 1904 may connect column 122 to a center of face 1806a. Bulkheads 1902a, 1902b, and 1904 may extend radially and perpendicularly from column 122 to outer column 1804 in section 1906a, and may extend radially and axially downward to outer column 1804 in section 1906b. In this manner, each radial bracket distributes downward force of tower-hosting column 122 to sections 1906a, 1906b of hexagonal outer column 1804. To maintain the radial orientation of bulkheads 1902a, 1902b, 1904, bulkheads 1908a, 1908b, 1910a, 1910b may be connected between columns 122, 1804, and between adjacent pairs of bulkheads 1902a, 1902b, 1904. For example, bulkhead 1908a may be connected to bulkhead 1902a and 1904, and bulkhead 1908b may be connected to bulkhead 1902b and 1904. Each bulkhead 1908a, 1908b may include stiffeners 1912, which run parallel to bulkhead 1904 and stiffeners 1914, which run perpendicularly to bulkhead 1904. Stiffeners 1912 may connect between face 1806a and column 122, or between face 1806a and a bracket, e.g., bulkhead 1902a. Stiffeners 1914 may connect between a bracket and one of stiffeners 1912, or between two adjacent stiffeners 1912. Bulkheads 1910a, 1910b are configured similarly to bulkheads 1908a, 1908b. In addition, girders 1916a . . . 1916e may be added to further maintain the configuration of column 122, and reinforce face 1806a. Girders 1916a . . . 1916e may each connect perpendicularly to face 1806 and between adjacent radial bulkheads 1902a and bulkhead 1904. Vertically oriented girders 1922a, 1922b may be added between each pair of adjacent radial brackets about column 122 at the upper area and approximately halfway from column 122. Each girder, e.g., girders 1916a . . . 1916e, may be further supported by tripping brackets that connect the girder to the (transparent) faces of the hexagonal outer tower-hosting column. Example tripping brackets 1926, 1928 are indicated and connect girders to (transparent) faces 1806f, 1806a, respectively. Each girder 1916a . . . 1916e may be provided with a stiffener 1918 at an inner edge to help prevent the girder from deforming under load. Similarly, each radial bulkhead may be provided with a flange 1920 at an inner edge. In embodiments, stiffeners 1918 and 1920 may extend perpendicular in one direction from the bulkhead to create an “L” shape, or in both directions from the bulkhead to create a “T” shape. In embodiments, stiffeners 1924a, 1924b may be added that run longitudinally (1924a) or a combination of longitudinally and axially (1924b) on the surface of each radial bulkhead 1902a, 1902b, 1904. Thus configured, tower-hosting column 122 terminates above bottom tower hosting column node 200 and middle tower-hosting column 1900 transfers loads from tower-hosting column 122 to hexagonal outer tower-hosting column 1804.

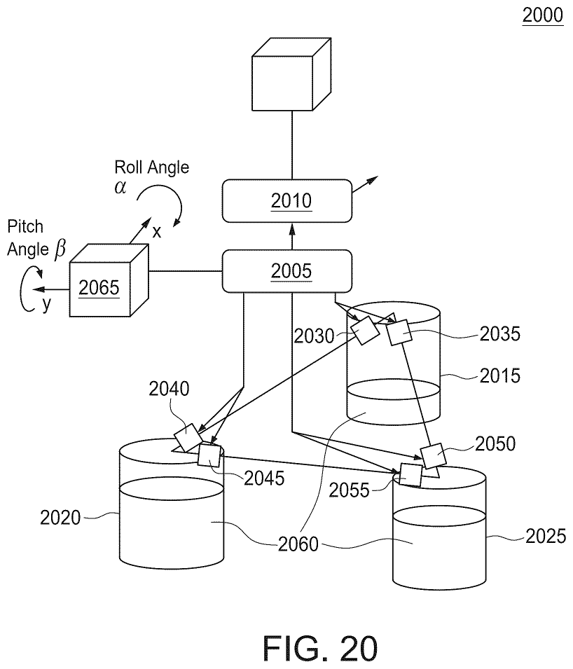

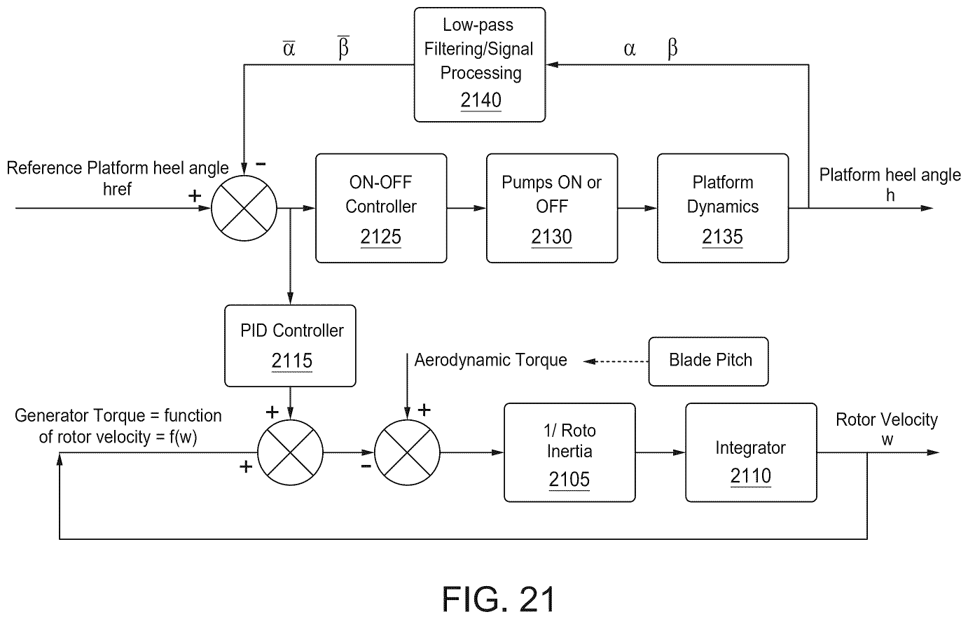

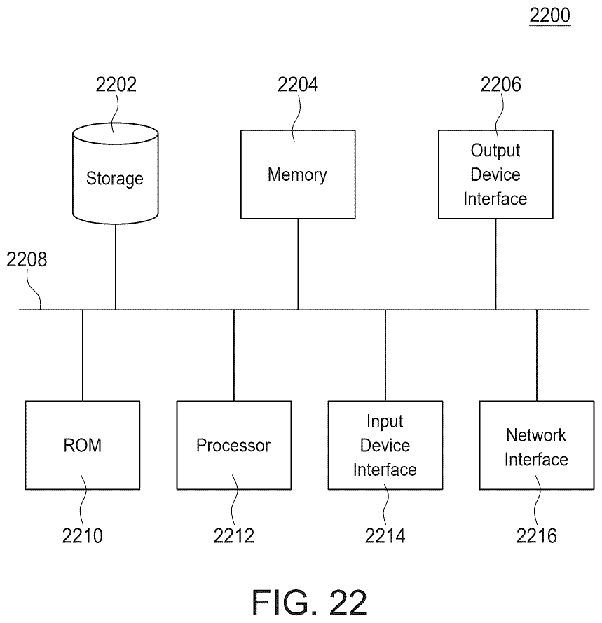

FIG. 20 shows a floating wind turbine platform 2000 with decoupled marine system 2005 and wind turbine controllers 2010. The HTS implemented in FIG. 20 and further described with reference to FIG. 21 and FIG. 22 may be used in any of the semi-submersible platforms in this disclosure with three stabilizing columns. For more redundancy and for a more efficient system, two pumps can be installed at each of the first stabilizing column 2015, second stabilizing column 2020, and third stabilizing column 2025. Each of the six pumps (2030, 2035, 2040, 2045, 2050, and 2055) may transfer ballast 2060 from the column at which the pump resides to the column to which the pump is connected.

For example, the first column 2015 has two pumps: pump 2030 and pump 2035. The pumps work on an on-and-off basis. They are switched on only occasionally, e.g., when the wind speed or direction changes significantly, to attain the desired platform inclination. The controller is optimally set to turn on the pumps on average a few times per day, despite considerable dynamics due to wind and wave disturbance, in order to avoid pump fatigue and excessive energy expenditures on the platform. The pumps may also not be located in the columns in which water is being transferred. For example, pumps may be located in the central column and move water between the perimeter columns via a series of pipes and valves.

The platform is fitted with motion sensors 2065 to measure the platform angular motions that can be used as input signals for the marine system controller. Accelerometers or inclinometers may be composed of a simple moving mass mounted on springs that track gravity. They both sense the acceleration due to the rotation of the platform, but also due to the linear accelerations—in surge, sway, and heave.

As far as this marine system controller is concerned, both a bi-axial pitch-and-roll inclinometer or a bi-axial surge-and-sway accelerometer are acceptable since linear accelerations (surge and sway) can be transformed into angular motions (pitch and roll). Both sensors are acceptable so long they track the gravity component of the platform, which is similar to the low-frequency angular motions. These motions sensors can be installed at any location on the platform. Usually for redundancy again, several motion sensors are installed in different columns and their measurement outputs are compared at all times before being fed into the control loop.

FIG. 21 is a flow chart for controlling a floating platform according to an embodiment. In FIG. 21, the platform roll angle (α) and pitch angle (β) signals are provided by the platform sensors and input to the controller. In an embodiment, the measured roll and pitch angle signals are low-pass filtered (α̅ and β̅) to remove high-frequency disturbances, such as, e.g., those resulting from the wave and wind dynamic and stochastic effects. In an embodiment, the platform roll and pitch angles are low-pass filtered by a signal processing 2140 using standard low-pass filtering strategies such as high-order Butterworth filters. In an embodiment, the filtering may be performed in advance of the controller receiving the signals. And in an embodiment, the filtering may be performed by software or hardware components of the controller itself.

FIG. 21 shows the logic behind the feedback controller. The filtered platform roll and pitch angles, α̅ and β̅, are input signals to the controller at 2125, provided by the platform sensors. Firstly, the measured signals are low-pass filtered at 2140 as discussed. Based on the filtered platform pitch and roll angles, α̅ and β̅, the relative angles θᵢ₋ⱼ between column top centers i and j, are derived based on platform geometry with columns at the vertices of an isosceles or equilateral triangle.

The following convention is used. If θᵢ₋ⱼ is positive, it means that column i is higher than column j. The error determined using Equation 7 is the error used as an input of the controller. Based on the sign of the error, eᵢ₋ⱼ, the correct pump Pᵢ₋ⱼ will be turned on at 2130 provided that eᵢ₋ⱼ is greater than a certain value that defines the dead-band for ON. The pumps Pᵢ₋ⱼ or Pⱼ₋ᵢ will be switched off provided that eᵢ₋ⱼ is less than a certain value that defines the dead-band for OFF. Depending on the relative angles θᵢ₋ⱼ, one, two, three or four pumps will be on. With this algorithm based on the relative angles between column top centers, the fastest water transfer path is always considered, thus the platform attains the desired angle very quickly or as fast as possible in every situation. Automatic bypass is also functioning with that approach, if one pump is suddenly deficient. The platform dynamics are measured, including its roll and pitch angles, α and β, at 2135 and used to provide a heel angle measurement fed back into the feedback loop.

A standard Proportional-Integral-Derivative (PID) controller could also be used in the determination of based on the heel angle error, but a simple on-off controller preceded by a filtered signal can be sufficient, due to the high inertia and relatively slow speed of the actuators of the system.

The wind turbine controller includes a number of instruments, a number of actuators, and a computer system (or a microprocessor) able to process the signals input by the instruments and communicate these signals to the actuators. The main objective of the wind turbine controller is the maximization or generation of the power production and the minimization or reduction of the extreme loads on the wind turbine components. In an embodiment, the features of a wind turbine controller may be incorporated into an integrated controller.

Two types of control are usually performed by the system. The supervisory control allows the turbine to go from one operational state to the other. Examples of operational states are start-up, power production, normal shutdown, emergency shutdown, standby, and so forth.

The second type of control performed by a wind turbine is called closed-loop control and occurs at a given operational state of the turbine to keep the turbine at some defined characteristic or operational boundary for that state.

The wind turbine thrust force F_{T}, the aerodynamic torque Tᵣ, and the power Pᵣ vary according to:

$$\{ \begin{matrix}{F}_{T} = \frac{1}{2} ρ A {C}_{T} ( λ , Δ ) {V}^{2} \\ {T}_{r} = \frac{1}{2} ρ A {RC}_{q} ( λ , Δ ) {V}^{2} \\ {P}_{r} = \frac{1}{2} ρ A {C}_{p} ( λ , Δ ) {V}^{3}\end{matrix} \qquad Equations 12 A , 12 B , 12 C$$

Where ρ is the density of air, R is the rotor radius, A is the apparent rotor swept area, V is the wind speed, C_{T} is the thrust coefficient, C_{q} is the torque coefficient, and Cp is the power coefficient. The non-dimensional coefficients (C_{T}, C_{q}, and Cp) depend on two parameters)(the speed-tip ratio λ and the blade pitch angle Δ,), while thrust force F_{T}, aerodynamic torque Tᵣ, and power Pᵣ depend on three parameters: the speed-tip ratio λ, the blade pitch angle Δ, and the global offset angle epsilon ε (the vertical component of an angle between the wind direction and the turbine axis, (Aₐₚₚₐᵣₑₙₜ=A cos ε, when the turbine is pointed directly toward the wind with zero horizontal offset)). The speed-tip ratio is the ratio of the angular speed of the rotor ω multiplied by the blade radius and divided by the wind speed V.

Typically, in power production mode, depending on the wind speed, two control regions called partial load and full load require different control strategies.

In partial load, when the wind speed is below the rated wind speed—the lowest wind speed at which the turbine produces the maximum power—the controller will vary the generator torque to maximize the aerodynamic power capture, while keeping the blade pitch angle Δ at its optimal setting.

Basically, the generator torque can be controlled to any desired value, which is proportional to the square of the filtered generator speed, with the aim of varying the rotor rotational speed to maintain a constant and optimal tip-speed ratio λ.

During power production, sudden variations of wind speed or directions can occur quite often at the site of floating wind turbines. These variations directly impact the overall magnitude and direction of the thrust force of the turbine applied to the rotor disk area in the direction of the wind. Viewed from the supporting platform far below the wind turbine hub, the thrust force represents an overturning moment to be withstood, and can yield high platform heel angles. Even if temporary, these high heel angles are detrimental to the overall system design life, and should be minimized during the unit lifetime.

In an embodiment, an integrated controller controls the wind turbine and the ballast pump simultaneously, in order to maintain the platform heel angle below a certain limit at all times or as desired. This controller may have platform control features integrated into a wind turbine controller modified to interact directly with the ballast pumps to minimize the heel angles of the floatation frame. A benefit brought by this is a rise in the structural design life of the floatation frame if the same amount of construction material (most of the case, it is steel) is used, without sacrificing the overall power output of the turbine.

Based on industry experience, instantaneous heel angles of up to 15 degrees could be reached by a floating wind turbine platform when the maximum thrust of the wind turbine is applied at the hub height. If the two controllers are decoupled, as described with regard to FIG. 20, the platform marine system controller works independently of the wind turbine. A simple signal can be shared between the two controllers to shut down the turbine if a fault occurs on the platform.

If the two control systems are completely decoupled, the platform will experience high heel angles in sudden shifts of wind speed or direction. The reason lies behind the difference in time constants for the two control systems. The turbine controller usually acts very quickly on the scale of a second, since it is designed to adapt to the quick disturbances of wind speed due to turbulence. The marine system controller is working on a timeframe of about ten minutes, because of the time necessary to pump water from one column to another.

For example, if the wind shifts from the cut-in wind speed to the rated wind speed in a matter of minutes, an extreme heel angle of about 15 degrees could be experienced by the floating platform, until the marine system controller triggers the appropriate ballast pumps to bring the platform back to even keel. At this high heel angle, the power output of the turbine would be reduced by the cosine of the heel angle of 15 degrees, since the rotor swept area is reduced because the blade plane is not perpendicular to the wind, as discussed earlier.

Thus, a platform high heel angle results in some loss in turbine power output. So, the marine system controller, even if used independently of the turbine controller, presents the benefit of keeping the tower at the desired alignment most of the time, but high heel angles are still experienced during transients (such as turbine startups or shutdowns) or sudden shifts of wind speed or wind direction.

In an embodiment, a floating wind turbine platform may have an integrated floating wind turbine and platform controller. In a specific embodiment of this invention, the wind turbine and platform controller directly controls the platform pumps (2030, 2035, 2040, 2045, 2050, and 2055), in order to remedy the issues presented by two decoupled controllers. The platform pitch and roll angle information obtained by motion sensors 2065 can be used directly by the turbine controller to keep the platform heel angle at, or within a desired range of a target inclination (see the discussion with regard to FIG. 10), at all times or as desired.

The integrated wind turbine controller would control either the generator torque or the blade pitch angle (or both at the same time). Thus, as an example of integrated control of both the wind turbine and the platform, the integrated wind turbine controller may temporarily maintain the thrust of the turbine (not shown) at a central column (not shown) at the center of the platform) at a lower level, while water is being pumped from between the three or four columns (2015, 2020, and 2025). In other words, the change of thrust loading on the turbine resulting in an overturning moment will match or correspond to the change of righting moment due to the ballast water.

During that transition period—when the water 2060 is being pumped from column to column—the overall thrust and power output of the turbine could be lower, but the platform heel angle would also be lower and closer to the target angle, which would actually keep the power production higher, than if the platform heel angle was 15 degrees.

There is clearly a tradeoff between the platform maximum allowable heel angle and the power production. If the heel angle is kept too low, the change in thrust will be very small while water is being pumped, leading to a lower power output than if the ballast pumps were started after the change in thrust. If the heel angle is kept too high, the power output loss originates from the cosine term. In other words, an optimal point can be found at which the power production would be maximized at all times or sufficiently high, while the low-frequency platform heel angle would be kept low, leading to an increase in the design life of the platform (due to a reduction in cyclic low frequency loads caused by the mass of the rotor nacelle assembly in high heel angles).

However, in many cases, the main benefit of this system is truly the reduced amount of construction material for the platform, such as steel, which will improve the cost-effectiveness of floating wind turbine technologies.

In an embodiment, this integrated controller entails the modification of a conventional wind turbine controller to control the aerodynamic torque (or thrust force) of the wind turbine while allowing the activation of appropriate ballast water pumps.

Equations 12A, 12B, and 12C suggest that the thrust and the aerodynamic torque can be reduced if either the tip-speed ratio or the blade pitch are modified (or both at the same time). Therefore, these two parameters can be changed by the controller in partial load and in full load to maintain an aerodynamic torque that would minimize or reduce the platform heel angle.

At this stage, several options are considered depending on the operational state and the region of control for the wind turbine. For small angles, the platform heel angle h is a combination of roll and pitch and is defined as the squares root of the sum of the roll and pitch angles squared:

$$h = \sqrt{{α}^{2} + {β}^{2}} \qquad Equation 13$$

In an embodiment, in a first form, the generator torque demand could be adjusted to modify the tip-speed ratio λ or the rotor speed, in order to reduce the aerodynamic thrust when the platform heel exceeds a certain set point. The appropriate pumps could then be started up by the control system, and the torque demand would be constantly adjusted, until the pumps are turned off, and normal operation can restart.

During that transition period, the generator torque would be partially controlled based on the platform heel angles measured from the inclinometers or accelerometers. The conventional wind component of the generator torque is obtained through a direct measurement and low-pass filtering of the rotor velocity. With this strategy in mind, the torque of the turbine would be derived as a sum of two terms, one due to the platform heel, and one due to wind-induced conventional rotor velocity.

If the platform reaches a heel angle greater than a given set point (for example 5 degrees), this new control loop is called by the system. Automatically, the right pumps are switched on, while the desired torque would be calculated slightly differently to temporarily reduce the rotor aerodynamic torque (or thrust). This control loop comprises two branches.

FIG. 21 includes a flowchart for an integrated controller that is a modification of the previously described control loop. The modification includes the control of the rotor velocity in which generator speed (or rotor velocity) is first used as an input, low-pass filtered, and the generator torque is determined based on a formula or lookup table. Usually, the generator torque is directly proportional to the filtered rotor velocity squared. The aerodynamic torque T_{R} is an input to the controller, and will always try to be matched by the generator torque T_{G} command, based on the actual rotor velocity ω. The rotor inertia J 2105, and an integrator block 2110 come into play to represent the dynamic of the system described by Equation 14:

$${T}_{R} - {T}_{G} = J \dot{ω} \qquad Equation 14$$

In full load, or above rated wind speed, the power produced is close to the rated power, but the turbine must limit or reduce the aerodynamic power extraction (or the Cp coefficient) so as not to exceed turbine component design loads, such as the generator. This time, the rotor spins at a constant angular speed ω, so the only parameter that can reduce the power coefficient Cp is the blade pitch angle Δ.

The generator torque is also held constant at the rated torque, but could also be controlled. The additional aerodynamic power that could be extracted is thus shed by varying the blade pitch angle. An increase in blade pitch angle—when the leading edge of the blade is turned into the wind—diminishes the aerodynamic torque by decreasing the angle of attack, hence the lift on the blades. Here, conventional PI or PID control strategies are used to modify the blade pitch angle, based on the generator speed error between the filtered generator speed and the rated generator speed. In some cases, notch filters are used to prevent excessive controller actions at the natural frequency of certain turbine components, such as the drivetrain torsional frequency or the blade passing frequency.

The control loop is otherwise as described earlier with reference to FIG. 21 and uses the platform roll and pitch angles as input signals, calculates the heel angle of the platform in the frame of reference of the nacelle turned into the wind, low-pass filters this heel angle, and finally computes the second component of the desired torque using a PID controller 2115 based on the platform heel angle error.

In an embodiment, a flowchart for an integrated controller with a modification of the standard blade pitch control loop below PID controller 2115. In this modified control loop, the rotor velocity ω is measured, properly filtered and processed, and compared to its setpoint ω_{ref} (the rotor velocity at rated power), which creates an error signal. This rotor speed error signal is fed into a PI controller to compute the pitch command sent to the blade pitch actuator. The wind turbine continues to operate as the blade pitch angles are being controlled.

During a turbine startup, the PI controller sends a command to the blade pitch actuator to pitch the blades from feather (90 degrees) to the run position and let the wind accelerate the rotor until a certain speed is reached. The generator is then engaged and the wind turbine starts producing power.

Similarly, for a normal turbine shutdown, the blades are pitched from their run position to feather. The generator is disengaged, when the turbine slows enough to drop the power to zero.

In this modified loop, the blade pitch angle may also be modified to control the aerodynamic torque. The blade pitch command is computed based on the sum of the typical filtered rotor speed error component calculated with the PID controller, and a second component based on the platform heel angle error calculated again with PID controller 2115. The new pitch command is the sum of these two components only if the platform error exceeds a certain band of heel angle about the optimum angle δₒₚₜᵢₘᵤₘ (for example +/−1, 2, or 5 degrees around δₒₚₜᵢₘᵤₘ). In that case again, the controller presents a control loop with two branches, one branch dealing with the component based on the filtered rotor speed error, the other branch taking care of the other component based on the filtered platform heel angle error.

In an embodiment, a combination of these two forms of control is provided for both regions of turbine operation, in partial load and in full load. The modification of both the generator torque and the blade pitch angle in both regions would add flexibility in the control system, regardless of the control region. For certain types of turbines, it is already not atypical to see the blade pitch angle being controlled below rated wind speed, and the generator torque being controlled above rated wind speed.

Thus, on the same principle, the generator torque controller in the first form and the blade pitch controller in the second form could be combined to temporarily control the aerodynamic torque, while the water is being shifted from column to column. The combination of both strategies would improve the overall performance of this integrated controller.

Gentle startup and shutdowns procedures are definitively desirable, as they can be intense fatigue life drainers for the turbine and the floatation frame. In a specific embodiment, a feature of the invention also relates to a controller that is used in the case of startup and shutdowns on the same principles as the ones described in operation.

In the case of a startup, the blade pitch may be controlled to go from feather-to-pitch at the same speed as the ballast water is moved from column to column, so that the heel angle of the platform remains at or near the target angle at all times during the procedure. In the case of a shutdown, the blades would be controlled to go from pitch-to-feather while allowing the ballast water to maintain the platform at or near the target angle, until the turbine is stopped.

In both cases, the filtered platform heel angle error could be used as an input to an extra branch in the control loop to calculate the blade pitch at all times. As a result, the blade pitch increase or decrease is much slower than in the case of a conventional controller. Similarly, the generator torque ramp-up or ramp-down time could be increased to match the required ballasting time, in order to minimize or reduce the platform heel angle error at all times or as desired during startup and shutdowns. Again, a combination of blade pitch and torque control can be used simultaneously to produce the same intended results.

In an embodiment, the decoupled marine system 2005 and wind turbine controllers 2010, or integrated wind turbine and platform controller may receive information allowing the controller to anticipate a change in wind speed or direction at the wind turbine. Such an anticipated change may, for example, trigger a startup or shutdown of the turbine, or prompt the controller to adjust the turbine yaw to point the turbine into the anticipated wind direction. In either case, before the actual arrival of the anticipated wind change, the controller may pre-transfer water from column to column before any turbine action is performed. For instance, in the case of a turbine shutdown, the platform may be pre-inclined while the turbine is still spinning, so that half of the water ballast transfer is done upfront. The turbine would then be shut down, and the ballast water would continue to be transferred between columns until the platform is at or near the target angle.

The embodiment may be used to improve power production as well when the wind turbine or floating platform detects any significant anticipated change in wind speed or direction. In advance of correcting yaw or blade pitch or both, ballast water may be pre-adjusted in the platform columns, so that the error in the heel angle experienced by the platform with the eventual change in the wind speed or direction may be reduced. At all times or as desired, the amount of water in the different columns can be estimated based on the thrust force of the turbine and its applied direction, or based on the wind speed and the wind direction. Using such information, information, a look-up table may be derived that the controller could consult to pre-adjust the ballast water of the platform to anticipate the wind change and reduce the error in the platform inclination caused by the wind change.

Thus, in this embodiment, the controller may use two extra input signals: an estimate of the anticipated wind speed and anticipated wind direction. A pre-compensation algorithm would be applied to pre-adjust the amount of ballast water in the different columns. Instruments such as anemometers or Light Detection and Ranging or Laser Imaging Detection and Ranging (LIDAR) sensors can be installed for that purpose.

This strategy leads to two possibilities: it could be a complementary approach to refine the first integrated controller described in the previous section (more information comes from the wind measurements), or it could be a much simpler integrated controller decoupled with existing wind turbine control schemes (variable torque and pitch controllers), and therefore could be implemented in a much easier fashion.

FIG. 22 conceptually illustrates an example electronic system 2200 with which some embodiments may be implemented. Electronic system 2200 can be a computer, phone, PDA, or any other sort of electronic device. Such an electronic system includes various types of computer readable media and interfaces for various other types of computer readable media. Electronic system 2200 includes a bus 2208, processing unit(s) 2212, a system memory 2204, a read-only memory (ROM) 2210, a permanent storage device 2202, an input device interface 2214, an output device interface 2206, and a network interface 2216.

Bus 2208 collectively represents all system, peripheral, and chipset buses that communicatively connect the numerous internal devices of electronic system 2200. For instance, bus 2208 communicatively connects processing unit(s) 2212 with ROM 2210, system memory 2204, and permanent storage device 2202.

From these various memory units, processing unit(s) 2212 retrieves instructions to execute and data to process in order to execute the processes of the subject disclosure. The processing unit(s) can be a single processor or a multi-core processor in different embodiments.

ROM 2210 stores static data and instructions that are needed by processing unit(s) 2212 and other modules of the electronic system. Permanent storage device 2202, on the other hand, is a read-and-write memory device. This device is a non-volatile memory unit that stores instructions and data even when electronic system 2200 is off. Some embodiments of the subject disclosure use a mass-storage device (such as a magnetic or optical disk and its corresponding disk drive) as permanent storage device 2202.

Other embodiments use a removable storage device (such as a floppy disk, flash drive, and its corresponding disk drive) as permanent storage device 2202 Like permanent storage device 2202, system memory 2204 is a read-and-write memory device. However, unlike storage device 2202, system memory 2204 is a volatile read-and-write memory, such as random-access memory. System memory 2204 stores some of the instructions and data that the processor needs at runtime. In some embodiments, the processes of the subject disclosure are stored in system memory 2204, permanent storage device 2202, and/or ROM 2210. For example, the various memory units include instructions for controlling an inclination of a floating wind turbine platform in accordance with some embodiments. From these various memory units, processing unit(s) 2212 retrieves instructions to execute and data to process in order to execute the processes of some embodiments.

Bus 2208 also connects to input and output device interfaces 2214 and 2206. Input device interface 2214 enables the user to communicate information and select commands to the electronic system. Input devices used with input device interface 2214 include, for example, alphanumeric keyboards and pointing devices (also called “cursor control devices”). Output device interface 2206 enables, for example, the display of images generated by the electronic system 2200. Output devices used with output device interface 2206 include, for example, printers and display devices, such as cathode ray tubes (CRT) or liquid crystal displays (LCD). Some embodiments include devices such as a touchscreen that functions as both input and output devices.

Finally, as shown in FIG. 22, bus 2208 also couples electronic system 2200 to a network (not shown) through a network interface 2216. In this manner, the computer can be a part of a network of computers, such as a local area network, a wide area network, or an Intranet, or a network of networks, such as the Internet. Any or all components of electronic system 2200 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software aspects of the subject disclosure can be implemented as sub-parts of a larger program while remaining distinct software aspects of the subject disclosure. In some embodiments, multiple software aspects can also be implemented as separate programs. Finally, any combination of separate programs that together implement a software aspect described here is within the scope of the subject disclosure. In some embodiments, the software programs, when installed to operate on one or more electronic systems, define one or more specific machine embodiments that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray™ discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The following paragraphs set forth enumerated embodiments

Embodiment 1 is to a floatable, semi-submersible platform comprising: a turbine-tower-hosting column having a top end and a keel end; an irregular polygonal top node connected proximate to the turbine-tower-hosting column top end; a regular convex polygonal bottom node connected about the turbine-tower-hosting column proximate to the turbine tower-hosting column keel end; three stabilizing columns, each having a top end and a keel end; three upper main beams, each upper main beam having a first end connected to the top node, and having a second end connected proximate to the top end of one of the three stabilizing columns; three lower main beams, each lower main beam having a first end connected to the bottom node, and a second end connected proximate to the keel end of one of the three stabilizing columns; fixed ballast components located within the turbine-tower-hosting column and within the lower main beams; hull trim compartments for containing ballast provided in the three stabilizing columns; and a hull trim system (HTS) for controlled transference of ballast between the hull trim compartments.

Embodiment 2 is to the floatable, semi-submersible platform of claim 1, wherein the turbine-tower-hosting column is a cylindrical turbine-tower-hosting column, the floatable, semi-submersible platform further comprising: a wind turbine tower connected to the cylindrical turbine-tower-hosting column; and, a wind turbine having a set of blades, wherein the wind turbine and set of blades are characterized by a rated operating rotor frequency (1P) and a blade passing frequency; and wherein, the wind turbine tower, when mounted onto the semi-submersible platform, is characterized by a natural frequency separated from the blade passing frequency at rated rotor speed by at least 10%.

Embodiment 3 is to the floatable, semi-submersible platform of claim 1, wherein each lower main beam includes a flat-plate pontoon.

Embodiment 4 is to the floatable, semi-submersible platform of claim 1, wherein each stabilizing column is polygonal and wherein each upper main beam second end includes a first section having a width of the upper main beam and a second section having a width of a face of the polygonal stabilizing column, the width of the upper main beam being less than the width of the face of the polygonal stabilizing column.

Embodiment 5 is to the floatable, semi-submersible platform of claim 1, wherein the hull trim compartments provided in the stabilizing columns are biased toward the side of the stabilizing column closest to the turbine-tower-hosting column.

Embodiment 6 is to the floatable, semi-submersible platform of claim 1, wherein the fixed ballast components are provided at the keel end of the turbine-tower-hosting column and within each of the three lower main beams at a section of each of the lower main beams nearer the turbine-tower-hosting column than the stabilizing column.

Embodiment 7 is to the floatable, semi-submersible platform of claim 1, wherein the cylindrical turbine tower-hosting column has a wall thickness of a first thickness nearer to the top end and a second thickness less than half the first thickness nearer to the keel end.

Embodiment 8 is to the floatable, semi-submersible platform of claim 7, wherein the cylindrical turbine tower-hosting column has a third wall thickness in a first section above a waterline, the third wall thickness being greater than the wall thickness of a second section immediately above the first section and being at least half the first thickness.

Embodiment 9 is to the floatable, semi-submersible platform of claim 7, wherein the cylindrical turbine tower-hosting column has a plurality of sections between the top end and the keel end, each section of the plurality having a different wall thickness, and the wall thickness of each section being greater than the wall thickness of the immediately adjacent section closer to the keel end.

Embodiment 10 is to the floatable, semi-submersible platform of claim 1, wherein each lower main beam has a plurality of sections between the first end and the second end, each section of the plurality having a different vertical wall thickness with a first vertical wall of a first section nearer to the first end having a first thickness and a second vertical wall of a second section nearer to the second end having a second thickness less than half the first thickness.

Embodiment 11 is to the floatable, semi-submersible platform of claim 10, wherein each lower main beam has a third vertical wall of a third section having a third thickness, the third section including the second end, and the third wall thickness being greater than the second thickness of the second section.

Embodiment 12 is to the floatable, semi-submersible platform of claim 1, further comprising: for each adjacent pair of lower main beams, at least one planar gusset connecting the pair of lower main beams, the at least one planar gusset being connected to at least one of: an upper edge of a first lower main beam, an upper edge of the bottom node, and an upper edge of a second lower main beam; or a lower edge of the first lower main beam, a lower edge of the bottom node, and a lower edge of the second lower main beam.

Embodiment 13 is to the floatable, semi-submersible platform of claim 1, wherein the irregular polygonal top node has a regular convex hexagonal inner structure having, on each of three faces of the hexagonal inner structure, an isosceles trapezoidal extension, wherein each first end of an upper main beam connects to the irregular polygonal top node at a base of one of the isosceles trapezoidal extensions, and wherein the regular convex hexagonal inner structure includes, for each face of the hexagonal inner structure, a bulkhead extending radially from the turbine-tower-hosting column and connected perpendicular to the face.

Embodiment 14, is to the floatable, semi-submersible platform of claim 1, wherein the regular convex polygonal bottom node is a regular hexagon having: for each face of the hexagon, a first bulkhead extending radially from the turbine-tower-hosting column and connected perpendicularly to the face; for each intersection of adjacent faces, a second bulkhead extending radially from the turbine-tower-hosting column to the intersection; and a plurality of girder sections, each girder section extending perpendicularly inward from a face of the hexagon and extending perpendicularly between a first bulkhead and a second bulkhead.

Embodiment 15, is to the floatable semi-submersible platform of claim 6, wherein the fixed ballast components located within the turbine-tower-hosting column and within the lower main beams include at least one of: ballast compartments configured to be filled with water, or sections of rigid ballast.

Embodiment 16 is to the floatable semi-submersible platform of claim 4, wherein the hull trim compartments provided in the stabilizing columns being biased toward the side of the stabilizing column closest to the turbine-tower-hosting column, includes each hull trim compartment being contained within a first half of a stabilizing column nearer to the turbine-tower-hosting column than a second half of the stabilizing column.

Embodiment 17 is to the floatable semi-submersible platform of claim 16, wherein: the stabilizing columns have a cross-section that is a hexagon; the first half of the stabilizing column is defined by a bulkhead between opposing vertices of the hexagon; and each hull trim compartment is further defined by an upper stabilizing column bulkhead and a lower stabilizing column bulkhead such that the hull trim compartment is configured to receive ballast within a space within a stabilizing column that is: within the first half of the stabilizing column, below a lowest level of an upper main beam, and above a highest level of a lower main beam.

Embodiment 18 is to the floatable, semi-submersible platform of claim 1, wherein: the hull trim compartments provided in the stabilizing columns are biased toward the side of the stabilizing column closest to the turbine-tower-hosting column; the fixed ballast components are provided at the keel end of the turbine-tower-hosting column and within each of the three lower main beams at a section of each of the lower main beams nearer the turbine-tower-hosting column than the stabilizing column; the cylindrical turbine tower-hosting column has a wall thickness of a first thickness nearer to the top end and a second thickness less than half the first thickness nearer to the keel end; and each lower main beam has a plurality of sections between the first end and the second end, each section of the plurality having a different vertical wall thickness with a first vertical wall of a first section nearer to the first end having a third thickness and second vertical wall of a second section nearer to the second end having a fourth thickness less than half the third thickness.

Embodiment 19 is to a floatable, semi-submersible platform comprising: a cylindrical turbine-tower-hosting column having a top end and a keel end; a top node having a hexagonal cross section and being connected proximate to the turbine-tower-hosting column top end; a bottom node having a hexagonal cross section and being connected about the turbine-tower-hosting column proximate to the turbine-tower-hosting column keel end; a node-connecting column having a hexagonal cross section and connecting the top node to the bottom node such that sides of the node-connecting column are co-planar with corresponding sides of the top node and the bottom node and the cylindrical turbine-tower-hosting column extends co-axially within the node-connecting column; three stabilizing columns, each having a hexagonal cross section, a top end and a keel end; three upper main beams, each upper main beam having a first end connected to the top node, and having a second end connected proximate to the top end of one of the three stabilizing columns; three lower main beams, each lower main beam having a first end connected to the bottom node, and a second end connected proximate to the keel end of one of the three stabilizing columns; fixed ballast components located within the turbine-tower-hosting column and within the lower main beams; hull trim compartments for containing ballast provided in the three stabilizing columns; and a hull trim system (HTS) for controlled transference of ballast between the hull trim compartments.

Embodiment 20 is to the floatable, semi-submersible platform of claim 19, wherein both the top node and the bottom node share a common regular or irregular hexagonal cross section.

Embodiment 21 is to a floatable, semi-submersible platform comprising: a cylindrical turbine-tower-hosting column having a top end and a keel end; a top node having a hexagonal cross section and being connected proximate to the turbine-tower-hosting column top end; a bottom node having a hexagonal cross section; a node-connecting column having a hexagonal cross section and connecting the top node to the bottom node such that sides of the node-connecting column are co-planar with corresponding sides of the top node and the bottom node; an intermediate node connecting the turbine-tower-hosting column keel end to at least one of the node-connecting column or the bottom node; three stabilizing columns, each having a hexagonal cross section, a top end and a keel end; three upper main beams, each upper main beam having a first end connected to the top node, and having a second end connected proximate to the top end of one of the three stabilizing columns; three lower main beams, each lower main beam having a first end connected to the bottom node, and a second end connected proximate to the keel end of one of the three stabilizing columns; fixed ballast components located within the turbine-tower-hosting column and within the lower main beams; hull trim compartments for containing ballast provided in the three stabilizing columns; and a hull trim system (HTS) for controlled transference of ballast between the hull trim compartments, wherein the cylindrical turbine-tower-hosting column keel end does not extend to the bottom node.

Embodiment 22 is to the floatable, semi-submersible platform of claim 19 in combination with any of the enumerated embodiments 1 through 18.

Embodiment 23 is to the floatable, semi-submersible platform of claim 21 in combination with any of the enumerated embodiments 1 through 18 and 20.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an embodiment of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The previous description is provided to enable any person skilled in the art to practice the various aspects described herein. In the embodiments, the separation of various system components in the embodiments described above should not be understood as requiring such separation in all embodiments. Various modifications to these aspects will be readily apparent to those skilled in the art, and the generic principles defined herein may be applied to other aspects. That is, it should be understood that any of the embodiments, or aspects of any embodiment, described within, may form claimed subject matter, either individually or in combination and the subject matter of this description is not limited by the embodiments described above.

The term ‘polyhedron’ as used herein, as well as similar terms (e.g. polyhedral), in this and in subsequent embodiments and aspects, should thus be taken to mean an open polyhedron or a closed polyhedron, i.e., a three-dimensional structure with flat polygonal side faces, straight edges and sharp corners or vertices, whether or not the structure is closed or has one or more open sides.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference.

We claim:

1. A floatable, semi-submersible platform comprising:
a turbine-tower-hosting column having a top end and a keel end;
an irregular polygonal top node connected proximate to the turbine-tower-hosting column top end;
a regular convex polygonal bottom node connected about the turbine-tower-hosting column proximate to the turbine-tower-hosting column keel end;
three stabilizing columns, each having a top end and a keel end;
three upper main beams, each upper main beam having a first end connected to the top node, and having a second end connected proximate to the top end of one of the three stabilizing columns;
three lower main beams, each lower main beam having a first end connected to the bottom node, and a second end connected proximate to the keel end of one of the three stabilizing columns;
fixed ballast components located within the turbine-tower-hosting column and within the lower main beams;
hull trim compartments for containing ballast provided in the three stabilizing columns; and
a hull trim system (HTS) for controlled transference of ballast between the hull trim compartments.

2. The floatable, semi-submersible platform of claim 1, wherein the turbine-tower-hosting column is a cylindrical turbine-tower-hosting column, the floatable, semi-submersible platform further comprising:
a wind turbine tower connected to the cylindrical turbine-tower-hosting column; and,
a wind turbine having a set of blades,
wherein the wind turbine and set of blades are characterized by a rated operating rotor frequency (1P) and a blade passing frequency; and
wherein, the wind turbine tower, when mounted onto the semi-submersible platform, is characterized by a natural frequency separated from the blade passing frequency at rated rotor speed by at least 10%.

3. The floatable, semi-submersible platform of claim 1, wherein each lower main beam includes a flat-plate pontoon.

4. The floatable, semi-submersible platform of claim 1, wherein each stabilizing column is polygonal and wherein each upper main beam second end includes a first section having a width of the upper main beam and a second section having a width of a face of the polygonal stabilizing column, the width of the upper main beam being less than the width of the face of the polygonal stabilizing column.

5. The floatable, semi-submersible platform of claim 1, wherein the hull trim compartments provided in the stabilizing columns are biased toward the side of the stabilizing column closest to the turbine-tower-hosting column.

6. The floatable, semi-submersible platform of claim 1, wherein the fixed ballast components are provided at the keel end of the turbine-tower-hosting column and within each of the three lower main beams at a section of each of the lower main beams nearer the turbine-tower-hosting column than the stabilizing column.

7. The floatable, semi-submersible platform of claim 1, wherein the cylindrical turbine tower-hosting column has a wall thickness of a first thickness nearer to the top end and a second thickness less than half the first thickness nearer to the keel end.

8. The floatable, semi-submersible platform of claim 7, wherein the cylindrical turbine tower-hosting column has a third wall thickness in a first section above a waterline, the third wall thickness being greater than the wall thickness of a second section immediately above the first section and being at least half the first thickness.

9. The floatable, semi-submersible platform of claim 7, wherein the cylindrical turbine tower-hosting column has a plurality of sections between the top end and the keel end, each section of the plurality having a different wall thickness, and the wall thickness of each section being greater than the wall thickness of the immediately adjacent section closer to the keel end.

10. The floatable, semi-submersible platform of claim 1, wherein each lower main beam has a plurality of sections between the first end and the second end, each section of the plurality having a different vertical wall thickness with a first vertical wall of a first section nearer to the first end having a first thickness and a second vertical wall of a second section nearer to the second end having a second thickness less than half the first thickness.

11. The floatable, semi-submersible platform of claim 10, wherein each lower main beam has a third vertical wall of a third section having a third thickness, the third section including the second end, and the third wall thickness being greater than the second thickness of the second section.

12. The floatable, semi-submersible platform of claim 1, further comprising:
for each adjacent pair of lower main beams, at least one planar gusset connecting the pair of lower main beams, the at least one planar gusset being connected to at least one of: an upper edge of a first lower main beam, an upper edge of the bottom node, and an upper edge of a second lower main beam; or a lower edge of the first lower main beam, a lower edge of the bottom node, and a lower edge of the second lower main beam.

13. The floatable, semi-submersible platform of claim 1, wherein the irregular polygonal top node has a regular convex hexagonal inner structure having, on each of three faces of the hexagonal inner structure, an isosceles trapezoidal extension, wherein each first end of an upper main beam connects to the irregular polygonal top node at a base of one of the isosceles trapezoidal extensions, and wherein the regular convex hexagonal inner structure includes, for each face of the hexagonal inner structure, a bulkhead extending radially from the turbine-tower-hosting column and connected perpendicular to the face.

14. The floatable, semi-submersible platform of claim 1, wherein the regular convex polygonal bottom node is a regular hexagon having:
for each face of the hexagon, a first bulkhead extending radially from the turbine-tower-hosting column and connected perpendicularly to the face;
for each intersection of adjacent faces, a second bulkhead extending radially from the turbine-tower-hosting column to the intersection; and
a plurality of girder sections, each girder section extending perpendicularly inward from a face of the hexagon and extending perpendicularly between a first bulkhead and a second bulkhead.

15. The floatable semi-submersible platform of claim 6, wherein the fixed ballast components located within the turbine-tower-hosting column and within the lower main beams include at least one of: ballast compartments configured to be filled with water, or sections of rigid ballast.

16. The floatable semi-submersible platform of claim 4, wherein the hull trim compartments provided in the stabilizing columns being biased toward the side of the stabilizing column closest to the turbine-tower-hosting column, includes each hull trim compartment being contained within a first half of a stabilizing column nearer to the turbine-tower-hosting column than a second half of the stabilizing column.

17. The floatable semi-submersible platform of claim 16, wherein:
the stabilizing columns have a cross-section that is a hexagon;
the first half of the stabilizing column is defined by a bulkhead between opposing vertices of the hexagon; and
each hull trim compartment is further defined by an upper stabilizing column bulkhead and a lower stabilizing column bulkhead such that the hull trim compartment is configured to receive ballast within a space within a stabilizing column that is: within the first half of the stabilizing column, below a lowest level of an upper main beam, and above a highest level of a lower main beam.

18. The floatable, semi-submersible platform of claim 1, wherein:
the hull trim compartments provided in the stabilizing columns are biased toward the side of the stabilizing column closest to the turbine-tower-hosting column;
the fixed ballast components are provided at the keel end of the turbine-tower-hosting column and within each of the three lower main beams at a section of each of the lower main beams nearer the turbine-tower-hosting column than the stabilizing column;
the cylindrical turbine tower-hosting column has a wall thickness of a first thickness nearer to the top end and a second thickness less than half the first thickness nearer to the keel end; and
each lower main beam has a plurality of sections between the first end and the second end, each section of the plurality having a different vertical wall thickness with a first vertical wall of a first section nearer to the first end having a third thickness and second vertical wall of a second section nearer to the second end having a fourth thickness less than half the third thickness.

19. A floatable, semi-submersible platform comprising:
a cylindrical turbine-tower-hosting column having a top end and a keel end;
a top node having a hexagonal cross section and being connected proximate to the turbine-tower-hosting column top end;
a bottom node having a hexagonal cross section and being connected about the turbine-tower-hosting column proximate to the turbine-tower-hosting column keel end;
a node-connecting column having a hexagonal cross section and connecting the top node to the bottom node such that sides of the node-connecting column are co-planar with corresponding sides of the top node and the bottom node and the cylindrical turbine-tower-hosting column extends co-axially within the node-connecting column;
three stabilizing columns, each having a hexagonal cross section, a top end and a keel end;
three upper main beams, each upper main beam having a first end connected to the top node, and having a second end connected proximate to the top end of one of the three stabilizing columns;
three lower main beams, each lower main beam having a first end connected to the bottom node, and a second end connected proximate to the keel end of one of the three stabilizing columns;
fixed ballast components located within the turbine-tower-hosting column and within the lower main beams;
hull trim compartments for containing ballast provided in the three stabilizing columns; and
a hull trim system (HTS) for controlled transference of ballast between the hull trim compartments.

20. A floatable, semi-submersible platform comprising:
a cylindrical turbine-tower-hosting column having a top end and a keel end;
a top node having a hexagonal cross section and being connected proximate to the turbine-tower-hosting column top end;
a bottom node having a hexagonal cross section;
a node-connecting column having a hexagonal cross section and connecting the top node to the bottom node such that sides of the node-connecting column are co-planar with corresponding sides of the top node and the bottom node;
an intermediate node connecting the turbine-tower-hosting column keel end to at least one of the node-connecting column or the bottom node;
three stabilizing columns, each having a hexagonal cross section, a top end and a keel end;
three upper main beams, each upper main beam having a first end connected to the top node, and having a second end connected proximate to the top end of one of the three stabilizing columns;
three lower main beams, each lower main beam having a first end connected to the bottom node, and a second end connected proximate to the keel end of one of the three stabilizing columns;
fixed ballast components located within the turbine-tower-hosting column and within the lower main beams;
hull trim compartments for containing ballast provided in the three stabilizing columns; and
a hull trim system (HTS) for controlled transference of ballast between the hull trim compartments, wherein the cylindrical turbine-tower-hosting column keel end does not extend to the bottom node.
